(19) United States
(12) Patent Application Publication
(10) Pub. No.: US 2013/0339189 A1
(43) Pub. Date: Dec. 19, 2013

(54) METHOD AND APPARATUS FOR FACILITATING REAL ESTATE TRANSACTIONS

(71) Applicant: Jonathan Minerick, Cardiff-by-the-Sea, CA (US)

(72) Inventor: Jonathan Minerick, Cardiff-by-the-Sea, CA (US)

(21) Appl. No.: 13/921,134

(22) Filed: Jun. 18, 2013

Related U.S. Application Data
(60) Provisional application No. 61/661,307, filed on Jun. 18, 2012.
(60) Provisional application No. 61/799,290, filed on Mar. 15, 2013.

(51) Int. Cl. G06Q 30/06; G06Q 50/16

(52) U.S. Cl. CPC G06Q 30/0613; G06Q 50/16
USPC 705/26.41

(57) ABSTRACT

A method of facilitating transactions comprises gathering and storing, in a collection, data relating to an item, gathering and storing, in the collection, information from communications, relating to a purchase transaction sequence regarding the item, parsing the collection to extract items of data or information and incorporating at least a portion of the extracted items into transaction documents relating to the purchase transaction sequence, and providing transaction documents to at least one of prospective buyers or prospective sellers, through a platform adapted to facilitate communication between prospective buyers and prospective sellers.

### TECHNICAL FIELD

The present application relates generally to sales transactions and, more specifically, to methods and apparatus for facilitating real estate transactions.

### BACKGROUND

Traditionally, real estate transactions have been known to involve a notoriously complex and overwhelming set of interactions among numerous parties. Even before negotiations begin, listing a property for sale on the one hand, and shopping for property on the other, are detailed, time consuming activities. When a seller and buyer actually begin negotiations over a property, the process of reaching agreement and closing a sale involves many documents such as listings, appraisals, mortgage applications, offers, counter-offers, contracts, disclosures and more. Burdensome complexity is added to property transactions through the introduction of appraisers, mortgage brokers, and home inspectors, as well as compliance with sometimes-byzantine federal, state and local regulations. From end-to-end, the process of buying and selling property is often complicated, opaque and slow moving.

Consequently, buyers and sellers, especially those who infrequently engage in property transactions, often engage agents, or brokers, to facilitate their purchase or sale transactions. To be sure, agents serve useful purposes, and can alleviate some of the headaches that the principal buyers and sellers face. In fact, it is often necessary to work with a licensed and registered agent to have access to the entire multiple listing service (MLS) database of local real-estate market data including detailed property listings, dates listed, days-on-market, etc. Access to the MLS is helpful as a source of information for pricing properties according to comparable properties (“comps”), and determining appropriate offer amounts based on market conditions. Because so many agents that represent buyers and sellers participate in the MLS system, they have access to many more property listings and potential buyers than an individual could only hope to access on his or her own. Since non-licensed individuals cannot access MLS data, employing an experienced broker could potentially save time that would otherwise be spent researching real estate market information via other sources. Moreover, brokers can be helpful in guiding buyers and sellers through the real estate transaction process and associated paperwork.

With the advent of the Internet as a purchase vehicle for many types of items, including real property, more data has been made available to sellers and buyers. In fact, online real estate search engines such as trulia.com and Zillow.com®, for example, can provide buyers and sellers with access to many of the properties in MLS databases, without the need to engage an agent. However, many online real estate search engines obtain property information from a single, common data source. This common source does not provide all of the listings that are available through the MLS, however, and the common source tends to provide less-detailed information about individual listings than MLS data does. As a result, many people still decide to engage a broker, at least to obtain full access to MLS listings.

Involving a broker is not without its costs, though. A seller's broker typically charges a mid- to high-single-digit percentage of the sale transaction price as commission, and a seller's broker will often split the commission with a buyer's agent. For MLS-property transactions, the commission splits are typically governed by the rules of the real estate association that administers access to the MLS. Because broker commissions reduce the proceeds that would otherwise flow entirely to a seller, sellers may choose to list their properties “for sale by owner,” or “FSBO,” rather than engaging a broker. However, due to lack of access to the comprehensive MLS data and in order to tap the expertise of experienced brokers, as well as the marketing “boost” that an MLS listing often provides, FSBO sellers often decide to revert to a broker, especially after fruitlessly trying to sell their property for some time. Buyers, too, may feel compelled to engage an agent with access to the extensive MLS property listings. However, buyer's agents will often limit their searches to MLS properties, due to the well-established compensation mechanism that is in place. Although helpful in providing access to the MLS, brokers' interests are not always aligned with a buyer or seller, due to the generally accepted commission allocating practices. That is, in order to close a deal quickly, a broker may not be as inclined to hold out for a higher price as the seller might be, and a seller may be advised to close a deal quickly. Moreover, as noted, a buyer's agent may not provide a buyer with access to non-MLS listings.

An inherent paradox thus results: although buyers and sellers may not want to pay broker commissions in connection with their real estate transactions, their inability to access the property listings and networks of buyers accessible through the MLS often motivate them to engage a broker in order to help close a deal.

### SUMMARY

Various aspects of examples of the invention are set out in the claims.

According to a first aspect of the present invention, a method is provided for gathering and storing, in a collection, data relating to an item, gathering and storing, in the collection, information from communications, the communications relating to a purchase transaction sequence regarding the item, parsing the collection to extract items of data or information and incorporating at least a portion of the extracted items into at least one transaction document relating to at least a portion of the purchase transaction sequence, and providing at least one transaction document to at least one of one or more prospective buyers or one or more prospective sellers, through a platform adapted to facilitate communication between the one or more prospective buyers and the one or more prospective sellers.

According to a second aspect of the present invention, an apparatus is provided, including a first module adapted to gather and store, in a collection, at least one of data relating to an item and information from communications, the communications relating to a purchase transaction sequence regarding the item, a second module adapted to parse the collection to extract items of data or information and to generate at least one transaction document relating to at least a portion of the purchase transaction sequence, by incorporating at least a portion of the extracted items into the transaction document, and a third module adapted to provide at least one transaction document to at least one of one or more prospective buyers or one or more prospective sellers, through a platform adapted to facilitate communication between the one or more prospective buyers and the one or more prospective sellers.

According to a third aspect of the present invention a computer program product is provided, the computer program being embodied on a non-transitory computer-readable medium, and comprising computer code for causing an apparatus to perform at least the following: gathering and storing, in a collection, data relating to an item, gathering and storing, in the collection, information from communications, the communications relating to a purchase transaction sequence regarding the item, parsing the collection to extract items of data or information and incorporating at least a portion of the extracted items into at least one transaction document relating to at least a portion of the purchase transaction sequence, and providing at least one transaction document to at least one of one or more prospective buyers or one or more prospective sellers, through a platform adapted to facilitate communication between the one or more prospective buyers and the one or more prospective sellers.

### BRIEF DESCRIPTION OF THE DRAWINGS

For a more complete understanding of example embodiments, reference is now made to the following descriptions taken in connection with the accompanying drawings in which:

FIG. 1A is a flow chart illustrating a process according to an embodiment;

FIG. 1B is a flow chart illustrating a sub-process according to an embodiment;

FIG. 1C is a flow chart illustrating a sub-process according to an embodiment;

FIG. 1D is a flow chart illustrating a sub-process according to an embodiment;

FIG. 2 is a screen shot depicting a user interface useful in preparing a property listing in accordance with an embodiment;

FIG. 3 is a screen shot depicting a user interface for reviewing and analyzing “comps” in accordance with an embodiment;

FIG. 4 is a screen shot depicting a web page for interfacing with social media in accordance with an embodiment.

FIG. 5 is a screen shot depicting a data entry interface for generating an offer in accordance with an embodiment;

FIG. 6 is screen shot depicting a user interface for generating an offer in accordance with an embodiment;

FIG. 7 is a screen shot depicting a web page useful for submitting an offer in accordance with an embodiment;

FIG. 8A is a screen shot depicting an “offer status” web page in accordance with an embodiment;

FIG. 8B is a screen shot depicting a buyer's offer status window in accordance with an embodiment;

FIG. 9 is a screen shot depicting an “escrow status” web page in accordance with an embodiment;

FIG. 10 is a screen shot depicting a seller escrow status window in accordance with an embodiment;

FIG. 11 is a screen shot depicting a user interface useful for removing contingencies in accordance with an embodiment.

FIG. 12 is a screen shot depicting a “disclosure” web page interface in accordance with an embodiment;

FIG. 13 is a block diagram illustrating an example embodiment.

FIG. 14 is a flow chart illustrating a process according to an embodiment.

FIG. 15 is a screen shot depicting a web page for a buyer to begin a buyer-initiated offer compilation sequence, in accordance with an embodiment.

FIG. 16 is a screen shot depicting a web page for the entry of data related to a buyer-initiated offer, in accordance with an embodiment.

FIG. 17 is a screen shot depicting a web page for the continuation of data entry related to a buyer-initiated offer, in accordance with an embodiment.

FIG. 18 is a screen shot depicting a web page for transitioning between a buyer-initiated offer sequence and other offer-generation functionality, in accordance with an embodiment.

FIG. 19 is a screen shot depicting a web page for a seller to begin responding to a buyer-initiated offer, in accordance with an embodiment.

FIG. 20 is a screen shot depicting a web page for a seller to confirm whether an offer code has been received in connection with a buyer-initiated offer, in accordance with an embodiment.

FIG. 21 is a screen shot depicting a web page for a seller to enter a code corresponding to a respective buyer-initiated offer, in accordance with an embodiment.

FIG. 22 is a screen shot depicting a web page for a seller to confirm the property address and other contact information relating to the seller's response to a buyer-initiated offer, in accordance with an embodiment.

FIG. 23 is a screen shot depicting a web page for transitioning between a seller's response to a buyer-initiated offer sequence and other functionality for offers, responses and counter-offers, in accordance with an embodiment.

FIG. 24 is a screen shot depicting a web page for comparing third-party service provider offerings, in accordance with an embodiment.

FIG. 25 is a screen shot depicting a web page for comparing lender and loan offerings, in accordance with an embodiment.

FIG. 26 is a screen shot depicting a web page for displaying an agent's profile, in accordance with an embodiment.

FIG. 27 is a depiction of a list for the display of items and costs related to a contemplated transaction, in accordance with an embodiment.

FIG. 28 is a screen shot of a web page for use with transaction service payment functionality through an escrow holder, in accordance with an embodiment.

FIG. 29 is a screen shot of a web page for validation of transaction and property information in connection with transaction service payment through an escrow holder, in accordance with an embodiment.

FIG. 30 is a flowchart of an exemplary method for facilitating transactions in accordance with embodiments.

FIG. 31 illustrates an exemplary device within which the various embodiments may be implemented.

While the present invention is susceptible to various modifications and alternative forms, specific embodiments thereof are shown by way of example in the drawings and may herein be described in detail. The drawings may not be to scale. It should be understood, however, that the drawings and detailed description thereto are not intended to limit embodiments to the particular forms disclosed, but on the contrary, the intention is to cover all modifications, equivalents and alternatives falling within the spirit and scope of the present invention as defined by the appended claims.

### DETAILED DESCRIPTION OF THE DRAWINGS

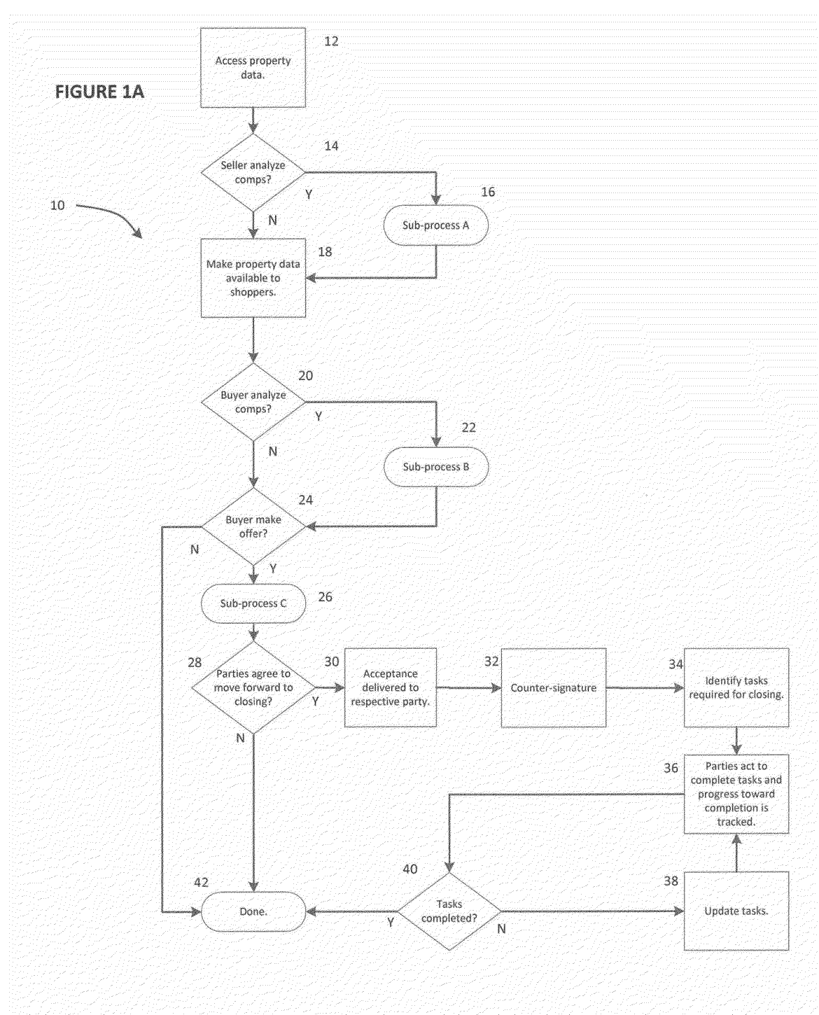

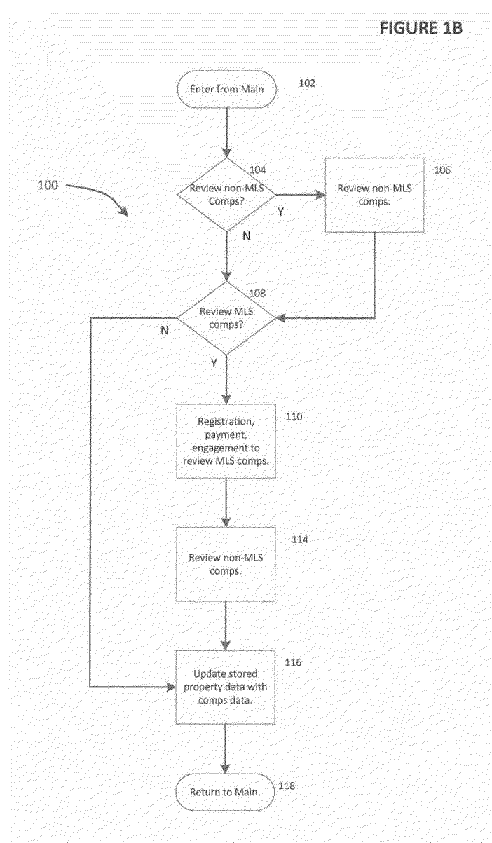

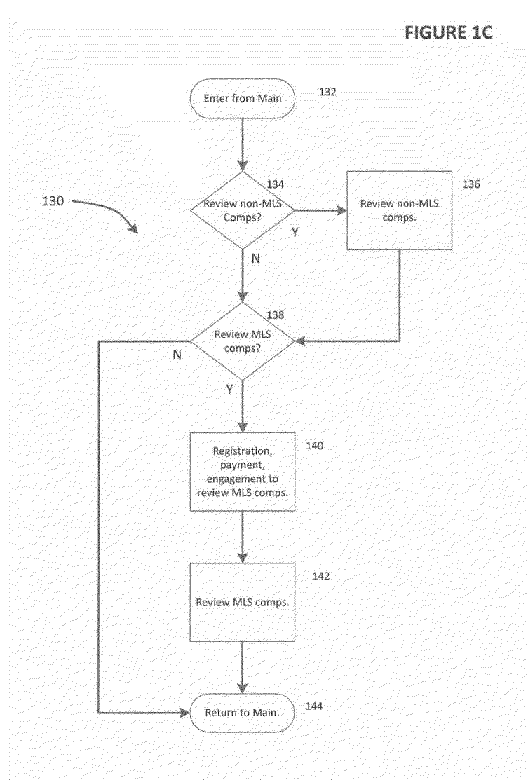

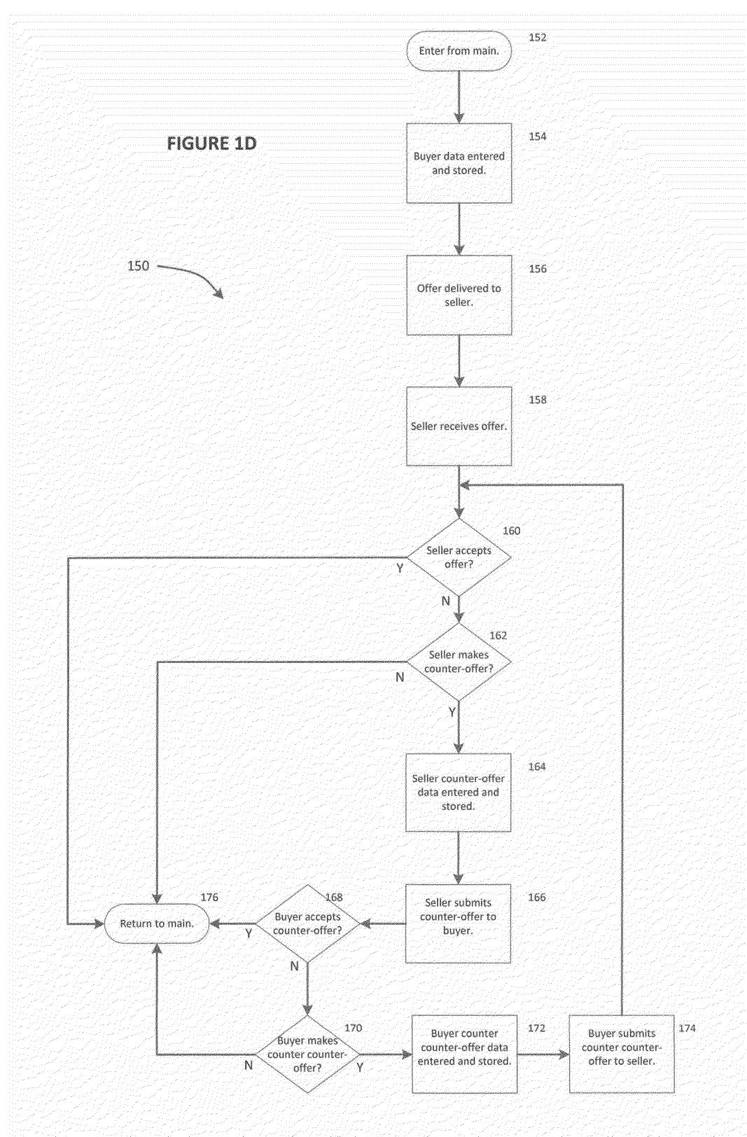

Example embodiments relate to methods and devices for facilitating real estate transactions, and their potential advantages are understood by referring to FIGS. 1-27 of the drawings. A process 10 for facilitating real estate transactions, or a related purchase transaction sequence, is shown, generally, at FIG. 1A. Referring again to FIG. 1A, data describing and relating to a real property for sale may be accessed at box 12. In an embodiment, property data may include property identifiers and descriptions of a piece of real property, as are commonly used in marketing such properties for sale. For example, property data may include details such as the property address, number of rooms, construction type, particular amenities and fixtures, photographs of the property, neighborhood description, tax data, local school system, etc. Property data may be input or recorded for storage through several known modes, as will be described in greater detail, below. In an embodiment, property data may be input, entered or stored before it is accessed, and more data may be input, entered and stored at the same time as previously input, entered or stored data is being accessed.

As will be described in greater detail, below, implementation of process 10 may be facilitated in embodiments through a platform or an application that allows a seller to proceed through a series of steps in a transaction process or purchase transaction sequence for accessing information about a property, analyzing the market, displaying a piece of property to shoppers and prospective buyers, engaging in a negotiation and closing transaction process or purchase transaction sequence, and facilitating other transaction-related activities such as facilitating communications between buyers, sellers and other related participants, managing escrow and generating and tracking lists of activities required for closing. Information from such communications may be gathered, aggregated, compiled and stored in a collection (e.g., a database). It is noted that these steps are not necessarily performed in a particular order. The functionality described allows a buyer, seller or other participant in the process to perform particular steps in a purchase transaction sequence when respective information is available, or to begin any particular step, jump to another step before completing the prior step, and return to complete an earlier step later in the process, in no particular order. In addition, embodiments may incorporate a real estate agent or broker to assist with certain tasks, or, alternately, provide for completion of a transaction without an agent or broker. Embodiments may be web-based, web-enabled or mobile-device enabled, as well, and provide for the input of various data and information via a graphical user interface or other input functionality.

In an embodiment, property data may be gathered, compiled, aggregated and stored in a collection. The collection may comprise, for example, a database such as may exist in digital storage media or the memory of a computing device. Although not necessary, in embodiments such a database may be configured to store property data by utilizing data structures for easy and user-friendly entry, as well as providing for manual or automated parsing, extraction or recall when needed in the process of marketing a property, for communication between various parties, or when a transaction between a buyer and seller is being facilitated. For example, relevant data relating to a particular property or properties that is input may be recalled for the automated or manual generation of promotional materials. In particular, items such as the address, number of rooms, number of bathrooms, construction type, etc. may be parsed or recalled from the collection/database, to be inserted directly into fields of predetermined templates, which may then be utilized in various property-marketing avenues. Listing sheets, “for sale” signs, and online real estate syndication sites and pages, among other items, may thus be generated manually or automatically using information that is drawn or parsed from stored property data. Stored property data may likewise be available for automated or manual entry into various documents related to the sale of real property, such as contracts, disclosure documents, and task lists, including related form documents or templates, as will be described in greater detail below. Storage of property information may thus advantageously and efficiently facilitate the conduct of a real estate transaction from start to finish, by allowing property data that is entered and storage to be used, accessed and reused as needed throughout the entire transaction. A particular item of property data thus only has to be entered once into an easily accessible repository, from where it can be readily accessed for manual or automated retrieval and use later. In an embodiment, property data may be updated throughout the course of marketing a property, or throughout the course of a related transaction. The references to such data in forms, templates, documents and other places where property data may appear throughout a transaction may be configured to be automatically updated, as appropriate, or as otherwise specified by the parties.

All or part of the data relating to a particular property or properties may be input for storage through various methods. For example, property data may be keyed into a computing device, or a terminal device that is connected to a database. Property data may also be imported, uploaded, downloaded, or accessed by a computing or terminal device, for example, from sources such as those connected through a network, as well as from memory or storage media. In an embodiment, one or more sellers, including corporate sellers of a particular property may establish an account, or separate accounts for the sale of property. Where a seller or sellers enter property data for multiple properties, data for each property may be maintained in a separate part of a database, so that only information relating to a specific property is displayed and accessed in connection with transactions regarding that particular property. They may do so by inputting particular payment and security-related information, as in common in various types of sales and service registrations. For example, a seller or sellers may be asked to create a profile which includes their name, address, telephone number, username, email address, password, credit card, bank account or other payment data, and other items that may useful in generating a profile and accounts for services, including for the use of Internet or web-based services. In embodiments, such accounts or profiles may be generated, or may be required to be generated, before the entry and storing of property data relating to a specific property or multiple properties. Payment information may be made accessible to automate or streamline payment for vendors or other third-party providers for transaction-related services at the time such services are provided or ordered. In an embodiment, such services may be provided on an “a la carte,” or as-needed basis, as will be described in greater detail below.

In certain situations, such as joint or corporate ownership of a property, more than one seller may be involved. The establishment of individual accounts for each seller may allow each of them to independently enter or provide for entry of property data, as well as access to the stored property data. Once an account is established, a seller or sellers may be granted access to additional features and functionality that are helpful or useful for marketing a property and initiating and finalizing a sales transaction. During the registration process, a seller or sellers may also be required to pay for listing and marketing a property as well as facilitating a property sale transaction, and other discrete related services. Moreover, especially where multiple sellers are involved in the sale of a single property, certain notifications and controls may be implemented to require acknowledgment and affirmation by all sellers for certain actions regarding the use of property data and certain steps in a real property transaction. That is, their accounts may be linked to facilitate communications as well as sharing, review and approval of relevant information among them.

In similar fashion, embodiments may provide for property shoppers and prospective buyers to open accounts and create profiles, as part of a broader platform for facilitating a purchase transaction sequence and related communications. As may be required of sellers in embodiments, buyers may also generate accounts and profiles, or be required to do so before viewing any property listings. An embodiment may be configured to allow shoppers and prospective buyers to view properties without first creating an account, while restricting other offer- and purchase-related functionality until an account is created by such a shopper or buyer. Buyers may also be required pay for access to sales listings, or to avail themselves of other transaction-related services. As will be described in greater detail below, selected property data stored by sellers may be made available to shoppers and prospective buyers to peruse and select properties for which to make an offer. Buyers may open secure accounts to store all or part of their own data that may be needed or useful to close a transaction, such as creditworthiness, mortgage approval status and other information needed to submit offers. In similar fashion as sellers, buyers can enter and store data for later manual or automatic parsing, extraction, retrieval and population into transaction documents. As discussed herein, transaction documents may include any documents generated, communicated or exchanged between the parties as part of the transaction process or purchase transaction sequence. For example, and as will be described in greater detail, below, these may include offers, counter offers, obligations, contingencies, disclosures, acceptances, contracts, and the like, which are utilized as part of a real estate transaction process or purchase transaction sequence. Data or information gathered, aggregated and stored in the collection (e.g., database), as described herein, may be selectively extracted as needed for a particular document or stage of a purchase transaction sequence. Moreover, corporate buyers and multiple buyers may be involved in a transaction for a single property. Their respective data may be managed and controlled for access in similar fashion as described for multiple or corporate sellers.

Security features such as usernames and passwords may be implemented to protect and manage the accounts and sensitive information of buyers and sellers, and embodiments may be configured to allow buyers and sellers to restrict others from accessing certain information that a seller or buyer has stored. Also, quick retrieval and access of sellers' or buyers' previously input or stored information may be facilitated through an abbreviated login procedure, so that a seller or buyer can avoid time-consuming re-entry of previously entered information. Detailed descriptions of security features, login procedures and features for limiting access are beyond the scope of this disclosure and are not required to understand the various embodiments disclosed.

In an embodiment, property data may also be generated as part of the step depicted at box 12. For example, inquiries or questionnaires can be posed to sellers to solicit specific property data that is useful for property marketing, but which a seller may not have considered to input on his or her own. Thus, a seller or group of sellers may not have to determine on their own the type of data that is helpful to market and actually close a sale of a property. Such inquiries and questionnaires can serve as a helpful guide, especially to first-time or infrequent sellers, who may not know the type of data sought in the property market. This can include the basics, such as number of bedrooms, neighborhoods location, etc., but can also include neighborhood-specific or regulatory-related items, and items that may be required for compliance with local sales contract regulations. Alternately, in an embodiment, a seller may simply be presented with a checklist to confirm the property data that a seller should be inputting or generating in preparation for the property sale process. Regardless of how the property data is input, transferred or generated, it may be stored in the database described above, partially or in its entirety, and accessed at box 12.

Once identifying and descriptive data relating to a particular property or properties has been accessed, such as at box 12 of FIG. 1A, a seller or group of sellers may be presented with an option to study and analyze “comparables,” in order to set a price for the property, as seen at decision diamond 14. Comparative sales may be studied to form an idea of the prices for which similar properties are selling or have sold. Comparative sales are well known in the real estate business as a means of determining a property value and asking price. Pricing and sale data for comparable properties, or “comps,” may be obtained from many sources. For example, data from property sales, such as property description, time on market, and sales price may be obtained from online directories. In an embodiment, listings input by other users may be gathered, stored and compiled in a collection, as in the database described above, so that a seller can peruse these listings in a web-enabled or mobile application. Items of data and information in the database can be filtered and sorted, and access to items in the database may be selectively granted to sellers, buyers, and other users. Sellers can also obtain sales data through public records of municipalities and other local authorities. This type of information, whether free or available for payment of a fee, may help sellers formulate strategy and determine asking price. In an embodiment, a report may be prepared for and provided to a seller to help price and market a property for sale. The data on comps may be generated through the review and analysis of real estate listings from various sources, including, without limitation, data of other sellers and buyers that is stored in an embodiment, as well as online sources, classifieds, and any other source of information on comparable sales.

Although embodiments may afford individual sellers and buyers access to troves of interested counter-parties and property listings for analyzing market conditions, certain buyers and sellers may wish to perform a more comprehensive analysis and avail themselves of additional data. A rich source of such property data is the Multiple listing service, or MLS. The MLS is a comprehensive set of real estate sales listings, as well as other sales and transaction data for a particular geographic location or area. Access to the MLS is often restricted to licensed real estate agents who are willing to share listings (sales agents) and split commissions with buyers' agents. The MLS thus constitutes a network through which buyer and seller agents have traditionally had access to much larger pools of properties or buyers than they could find on their own or through brokerage companies that employ them. The MLS may be a particularly useful tool for sellers to access a greater number of comparables that would not otherwise be available. However, it may come at an additional cost to a seller, or require making special arrangements with a licensed real estate broker.

If a seller or group of sellers decides to analyze comps, the seller(s) may launch sub-process A as shown at button 16. Referring now to FIG. 1B, a flow-chart of sub-process A is illustrated as sub-process 100. Button 102 indicates where sub-process 100 may begin when accessed from button 16 of FIG. 1. At decision diamond 104, a seller may elect to analyze and review non-MLS comps available from other sources, as described above. In an embodiment, a seller may be provided with a report generated through a search of non-MLS comps listings, as shown at box 106. Such a report may be generated by a real estate agent, or through automated search and reporting functionality, for example, for delivery to a seller. Access to such a report may also require payment, as discussed herein. The seller may thus search, analyze and review non-MLS comps as shown at box 106. Decision diamond 104 and box 106 accordingly depict steps that are part of an optional portion of subroutine 100, which may be made available if sources of comps are available other than the MLS. After completing his or her review and identifying relevant non-MLS comps, or if a seller elects at decision diamond 104 not to view non-MLS comps, the seller may be presented with an option to view MLS comps, as shown at decision diamond 108. If a seller decides to analyze and review MLS comps, the seller may have to complete registration, payment and third-party broker engagement requirements as illustrated at box 110. At box 110, a seller may also be presented with special forms and instructions required to register for such access. Moreover, when MLS services selected by sellers require payment, embodiments may provide for making payment arrangements by using information from a seller's stored profile or account, or by requesting credit card information. After completing any such registration, payment and broker engagement procedures, a seller may be provided with a report generated through a search of MLS listings, as shown at box 114. Such a report may be generated by a real estate agent, or through automated search and reporting functionality, for example, for delivery to a seller. In embodiments, a seller may be granted direct access to search, review and analyze the MLS database for relevant comps. Once the seller has searched comps, the seller may update and supplement the stored property data in the database by adding any relevant information identified during the comps research, as shown at box 116. Of course, a seller may decline to search MLS comps at decision diamond 108, in which case the database may simply be updated and supplemented by any relevant non-MLS comps data actually identified, if any, as shown at box 116. From box 116, a seller may return to button 16 of process 10 (FIG. 1A), as illustrated at button 118 of sub-process 100 (FIG. 1B). As described above, in connection with property data, information stored in the database regarding comps may be later referenced and retrieved for informational purposes of a transaction or to automatically or manually populate various transactional forms and documents where such data may be useful.

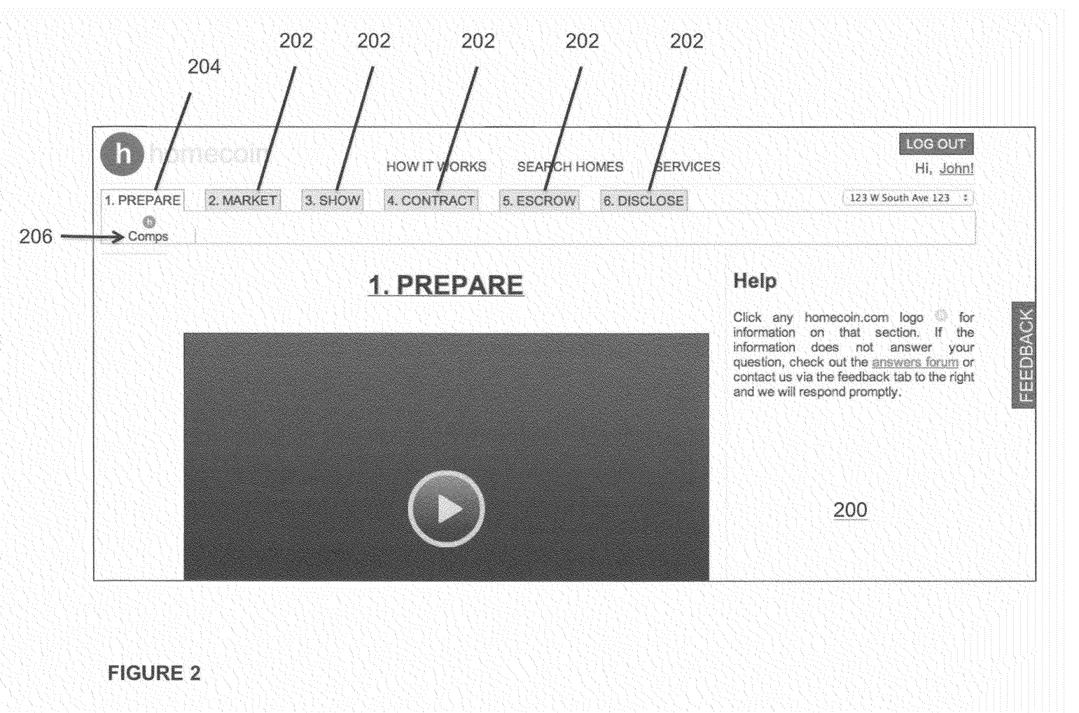

After returning to button 16, or if, at decision diamond 14 a seller or group of sellers decides not to analyze comps, the sellers may begin making property data regarding a particular property or group of properties available to shoppers and buyers immediately as shown at box 17 of FIG. 1A. As illustrated in FIG. 2, in an embodiment a web-based application may be configured with a web page 200 that allows staged progress through the process through the use of tabs 202 which may include links to deeper levels of related functionality, and additional information related to the particular functionality. For example, tab 204, labeled “Prepare,” may include links to a section or web pages that facilitate preparation of a listing that may be displayed to buyers. In an embodiment, clicking these links may also display information, advice and tips that sellers may find useful in preparing a home for sale, such as staging tips and maintenance checklists, for example. Link 206, labeled “Comps,” may include functionality and information helpful to a user in researching and analyzing comps in preparation for listing a property. Of course, it is not necessary for buyers, sellers and other related parties to progress through the tabs in a sequential linear order, or any other order. Rather, tabs 202 and links related to these tabs may allow buyers, sellers and others to work on a section of the transaction process or purchase transaction sequence, finish working, save the completed work to a database, and pick up at that point, or at a completely different point later. Moreover, a system of associated indicators, as described in greater detail below, may provide readily discernible signals regarding the completion status of the steps and tasks associated with the links and tabs. Such a system may itself track the progress of the transaction process or purchase transaction sequence, and provide a buyer or seller with “real-time” tracking of the transaction process, as well as letting the party know if additional input or information may be required. The system of indicators may be supplemented by alerts transmitted to a buyer, seller, or other related party, which affirmatively notify the party of a status change, completion, or of a requirement to provide further needed input or information.

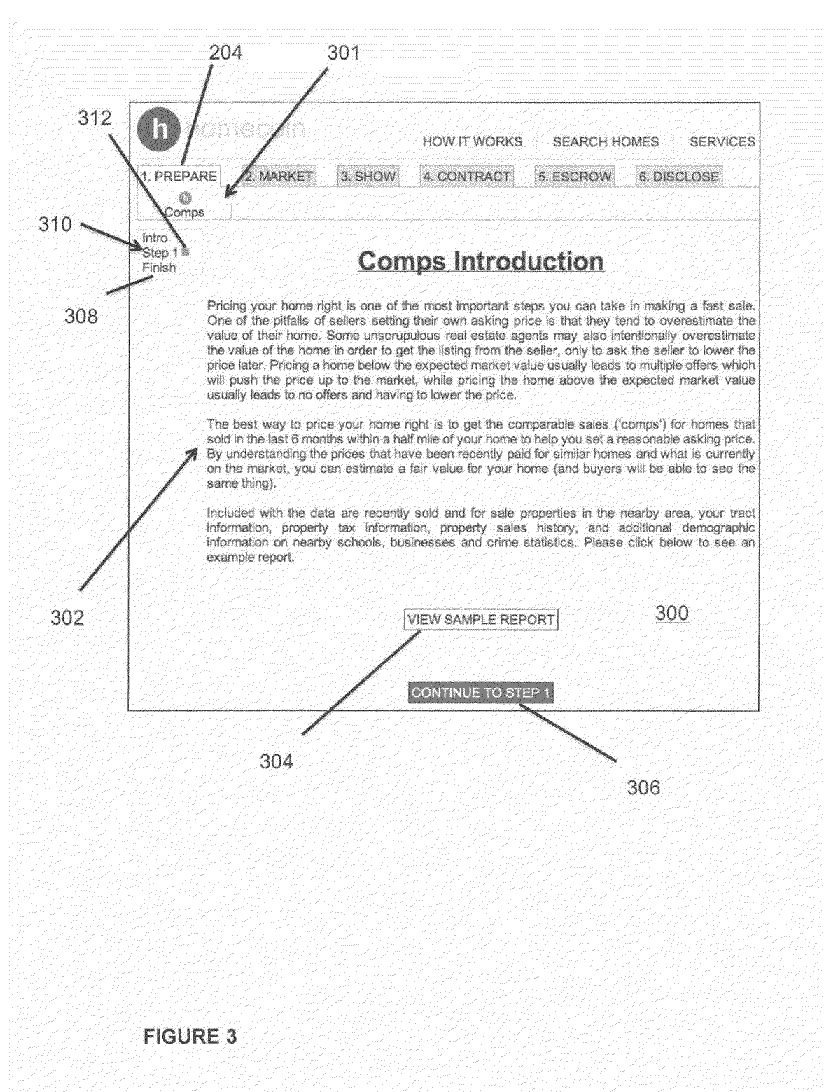

Referring again to FIG. 2, by clicking link 206, a seller may access web page 300, illustrated in FIG. 3. On web page 300, area 301 of tab 204 may be highlighted, shaded or include some other designation which indicates that the “Comps” stage is currently active, thus providing a seller a visual reference of the particular stage he or she is working on. Of course, the designation mentioned is not limited to the examples recited, and other types of visual and even non-visual indicators may be used to provide such an indication that a stage is currently active. Web page 300 may also provide introductory information 302 to a seller regarding comps, and may include a hyperlink 304 that facilitates viewing a sample report. Such a report may be provided through another webpage, or some other functionality that facilitates viewability, such as, without limitation, downloading or emailing a report. A sample report may help a seller or buyer better understand the comps data that is available, and how it may be useful. Also included on web page 300 may be a link 306 for beginning the process of reviewing and analyzing “comp” data. By clicking link 306, a seller may access deeper functionality for reviewing comps stored in a database, or accessing additional resources for information about comps, such as the MLS or other non-MLS sources, as described in greater detail above.

Referring again to FIG. 3, embodiments may include additional “task tracking” functionality to provide the seller with a visual indication of progress against specific tasks associated with researching comps. Indicator window 308 graphically illustrates to a seller the progress against tasks identified in window 308. For example, indicator window 308 may include a task 310 (“Step 1”) and an indicator 312. Indicator 312 may use a color-coding or a color-based system, or its shading or shape may change, to instantly provide a seller with the current status of respective task 310. In an embodiment, indicator 312 may be an object that is colored, shaded or has a particular shape that provide the seller with a visual indication of whether task 310 associated with indicator 312 has been completed. The color, shading or shape of indicator 312 may change when task 310 is completed. For example, indicator 312 may be colored red, to illustrate that Step 1 has not been completed. It may change to green when Step 1 is completed. Moreover, such indicators may be configured with more than 2 states, to provide reminders or status information regarding various interim stages or other information in addition to simply “complete” or “incomplete.” Information window 308 may include more than one task, which may be related to research and analysis of comps data, or other tasks associated with preparing to list or market a property to shoppers or prospective buyers. Moreover, embodiments are not limited to the use of color, shading or shape of indicator 312 to demonstrate the progress or status of a particular task. Rather, indicator 312 may be configured to employ any type of quickly recognizable characteristic or appearance to provide a seller or other viewer with an instant indication of task status. If the seller moves to another step in the transaction process or purchase transaction sequence and returns to webpage 300, he or she may thus have an immediate understanding of the status of tasks listed in information window 308. Of course, the method of providing a seller with the status of a particular task is not limited to the examples recited, and other types of visual and even non-visual indicators may be used in embodiments.

Referring again to FIG. 1A, after deciding whether to analyze comps data, or completing a review of comps data as shown at decision diamond 14, a seller may make certain stored property data available to shoppers and prospective buyers, as shown at box 18. The stored property data may be made available to shoppers and buyers in various formats, including a profile, or listing page that is displayed through a website. As discussed above, a seller may specify which particular items of stored property data and other information are to be included in the formats made visible to viewers such as shoppers and buyers. In embodiments, such viewable formats may include predetermined templates that manually or automatically recall or parse property data from the database where it is stored. Also, property descriptions such as profiles or listing pages may be tagged with a unique identifier that allows shoppers and prospective buyers to select, view, and identify properties for which they may desire additional information or to submit an offer. The unique identifier may be a number, string of alphanumeric characters, or any other easily recognizable item that facilitates identification and reference of individual property listings and obtaining additional stored property data such as from a database, as well as engagement in a respective transaction for the particular property.

In embodiments, properties may be displayed to shoppers and buyers in various modes and through multiple channels as selected by a seller. As discussed above, in connection with a web-based application, properties may be displayed in web pages that may be made visible to anyone, or limited to certain shoppers and buyers that may have opened accounts through a web-based application, for example. Sellers may also select other methods of alerting shoppers and buyers and making property data available to them. In embodiments, services such as printed “for sale” signs and listing sheets may be ordered and paid for by sellers on an “a la carte” basis. Such items may be provided by third-party vendors or other providers, and printed and delivered for distribution by the seller, or set up and distributed through third-parties that provide such services. Such signs, flyers and other items may include a unique property identifier, as described above, that a shopper or buyer may use to reference properties and obtain additional property data, such as from a database, when preparing to engage a seller or begin a real estate transaction. Payment for third-party services and additional promotional or marketing items may be facilitated through information a seller has included in his or her profile or account and is stored in a database, as discussed in greater detail above. Alternately, a seller may be prompted to enter data and information that is needed or helpful to facilitate payment (e.g., credit card or bank account information), or any other types of payment arrangements may be utilized that allow a user to pay a third-party for such services.

Embodiments may also provide for sellers to market properties through other channels such as Internet syndication and social media. For example, functionality may be included that facilitates connection with and publication of property data stored in the database through Internet syndication services and social media networks, such as Facebook®, Twitter®, LinkedIn°, and others. Such functionality may provide for direct links to upload and transfer data and information to an Internet syndication service or social media network directly from the database where it is stored, such as information from a seller's account, profile, etc.

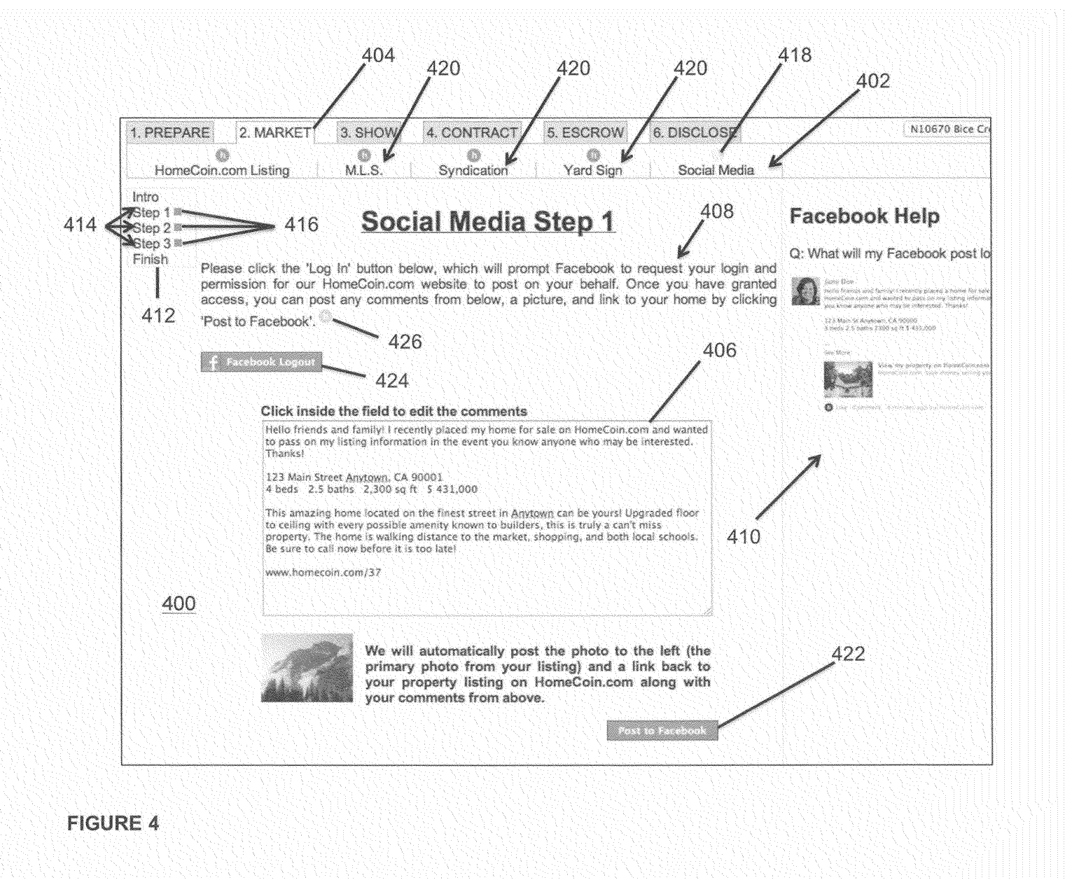

Referring now to FIG. 4, there is illustrated web page 400. Web page 400 may appear when link 402 (“Social Media”) is selected, under tab 404 (“Market”). As described in connection with other functionality herein, link 402 may be highlighted, shaded or include some other visually-recognizable or non-visual indicia for indicating that link 402 is active for the seller to work in. Web page 400 may include text field 406, for a seller to enter relevant property data for posting to and displaying through social media, as well as related instructions 408 and a “help” field 410, where a seller may obtain further guidance about social media websites and applications. Web page 400 may also include directions or instructions to guide a seller in entering social media account login information. As described in connection with other functionality described herein, web page 400 may include task field 412, where discrete tasks 414 and indicators 416 may be included to provide a reference as to the completion status of various tasks associated with link 402, as well as a reminder that certain tasks may not have been completed. Moreover, link 402 may include a separate status indicator 418, which may indicate whether all tasks associated with link 402 have been completed, or whether some tasks remain incomplete, so that a seller may quickly discern the completion status. Indicator 418 operates in similar fashion as the indicator functionality described in connection with FIG. 3. For example, color-based status indicia may be employed to apprise a user of the current status of a particular item, and status indicator 418 may thus be colored yellow. Status indicator 418 may remain visible even when a seller is working on tasks under other links 420, so that a seller may be constantly aware of the completion status and reminded when tasks associated with particular links 402, 420 are incomplete or may require further attention. Of course, the method of providing a seller with an indication of the completion status as mentioned in the preceding sentences is not limited to the examples recited; and other types of visual and even non-visual indicators may be used to provide information regarding completion status, and other information, to a seller.

When a seller has entered the property data desired to be posted to or displayed on a social media site, the seller may click button 422 to actually transmit the property data to the social media site for posting or display. In embodiments, clicking button 422 may trigger functionality for interfacing with a social media website or application, such as, without limitation, automated username and password entry and verification, as well as connecting through APIs or other methods of interfacing with social media sites and applications. In addition, a seller's login information may be stored in the database, as described above, and automatically accessed when the seller is interfacing with social media sites and applications. When a seller has completed posting, or decided not to post information or property data, the seller may logout of the social media site by clicking button 424. Help icon 426 may provide a link or access to additional instructions or description beyond those offered at 408. Information linked to help icon 426 may be accessed in various ways. For example, clicking or hovering a cursor over help icon 426 may cause a new window or pop-up “bubble” to appear with the relevant explanation or instructions. Or, clicking icon 426 may open another webpage or browser tab. Various types of functionality may be employed for this purpose, in keeping with embodiments.

Social media or Internet publications may include unique property identifiers that allow a viewing shopper or buyer to obtain more information or connect with a seller to negotiate and conduct a real estate transaction regarding the selected property. Thus, embodiments may take advantage of functionality that allows sellers to easily make stored property data available to a broad audience of shoppers and prospective buyers through multiple modes without having to re-enter the data when deciding to utilize new distribution and publication channels. Of course, distribution and publication of property data may be managed through a system of approvals and permissions, to avoid the inadvertent or unintentional distribution or publication through channels and distribution modes not desired by a seller or group of sellers.

When property data is made available to shoppers or prospective buyers, shoppers and buyers may peruse properties and begin the process of engaging a seller to negotiate sale terms and consummate a transaction. As discussed above, in an embodiment, access to view properties may be granted to anyone, and buyers may discover properties through other distribution and publication methods selected by sellers that employ unique identifiers that allow buyers to directly interface with sellers and engage in respective transactions. That is, in embodiments, it may not be required for shoppers and buyers to establish an account or profile to peruse and select properties. Buyers may search and discover properties through methods such as those described above, including logging onto a web-enabled or mobile application that displays property listings, for sale signs, web pages, Internet syndication, social media and others. In embodiments, any such items input by the buyer and other users may be gathered, aggregated and stored in a collection, e.g., in a database as discussed above, and access to such data and information may be selectively granted. Once target properties are identified, a buyer can use their respective unique identifiers to connect with the seller. However, at this point, an embodiment may be configured such that a buyer may be required to establish a profile or account and provide identifying data in order to take this step and engage a seller in negotiations. Secure access may be provided to a buyer for this purpose, and payment may be required to open an account or profile for purposes of engaging sellers, as well. Other relevant information may be requested of and provided by a buyer when setting up a profile or account may be used to facilitate payment.

In addition, when a buyer sets up a profile or account, the buyer or buyers may also research comps, to help establish their own idea of market pricing. Thus, as seen in FIG. 1A, at decision diamond 20, a buyer preparing to make an offer on a property may be asked to review comps, in similar fashion as a seller, as described above. If a buyer decides to review comps, related functionality may be launched or accessed at button 22. For example, button 22 may launch sub-process B, illustrated at FIG. 1C.

As discussed immediately above, regarding buyers, and further above, regarding sellers, comps may be reviewed or obtained in several ways. For example, in embodiments, a seller or buyer may be presented with reports enumerating comparative real estate listings and providing related information, whether from MLS data or non-MLS sources, rather than being granted access to comb through listings and reviewing and analyzing comps on his or her own. In an embodiment, a seller or buyer may be presented with a choice of receiving a report or reviewing comps by him or herself. Additional fees may be charged for this type of reporting service, which may be provided by a third party that is engaged or automatically receives a request when a seller or buyer requests such a comps report. Related costs may be charged to the account of a buyers or sellers, and payment may be facilitated by billing and payment data that may be entered by such parties contemporaneously, or in advance, as discussed above.

Referring now to FIG. 1C, there is shown a flow-chart of sub-process 130. Button 132 indicates where sub-process 130 may begin when accessed or launched from button 22 of FIG. 1A. At decision diamond 134, a buyer may elect to review non-MLS comps available from other sources, as described above. The buyer may then peruse and review non-MLS comps on his or her own, or review a report provided to a him or her, as shown at box 136. Decision diamond 134 and box 136 thus depict an optional portion of sub-process 130, which may be made available if sources of comps are available other than the MLS. After completing his or her review of non-MLS comps, or if a buyer elects at decision diamond 134 not to view non-MLS comps, the buyer may be presented with an option to review MLS comps, as shown at decision diamond 138. If a buyer decides to review MLS comps, the buyer may have to complete any registration, payment and third-party broker engagement requirements as illustrated at box 140 and discussed above in connection with similar seller-related functionality. At box 140, a buyer may also be presented with special forms and instructions required to register for such access. Moreover, when MLS services selected by buyers require payment, embodiments may provide for making payment arrangements contemporaneously, or by using information from a buyer's stored profile or account, or requesting credit card, bank account or other payment-related information, as discussed above in connection with seller review of comps. After completing any such registration, payment and broker engagement procedures, a buyer may be provided with a report generated through a search of MLS listings, as show at box 142. Such a report may be generated by a real estate agent, or through automated search and reporting functionality, for example, for delivery to a buyer. In embodiments, a buyer may be granted access to search, review and analyze the MLS database for relevant comps. After a buyer reviews MLS comps data at box 142, sub-process 130 may be exited at button 144, and process 10 (FIG. 1A) may be rejoined at button 22, and subsequently, decision diamond 24.

Of course, a buyer may decline to search MLS comps at decision diamond 138, in which case process 10 (FIG. 1A) may be rejoined at button 22, and subsequently, decision diamond 24, from button 144 of sub-process 130 (FIG. 1C). As described above in connection with property data, information gathered or received by a buyer regarding comps may be stored in a collection for later parsing, reference and retrieval for informational purposes of a transaction or to automatically or manually populate various transactional forms and documents where such data may be useful.

Referring again to FIG. 1A, box 24 illustrates the step of a buyer or buyers deciding to make an offer to a seller or group of sellers. Furnishing a seller or sellers with an offer may be an opening communication between the buyer(s) and seller(s). Other transaction-related communications facilitated by embodiments may include transmittal of counter-offers, counter-counter-offers and other notifications and information between buyers and sellers, some of which are illustrated in subroutine 150 depicted in FIG. 1D. Information from such communications, whether the entirety of the communication or particular items, may be gathered, aggregated, compiled and stored in a collection such as described herein (e.g., a database) Sub-process 150 may be entered from button 26 of process 10 (FIG. 1), at entry point 152 of process 150. At box 154, buyer information may be accessed or stored as described above in connection with accessing and storing property data and information about sellers. For example, once a property is selected and respective buyer accounts or profiles have been created, the account and profile information may be stored in a database. Also, a buyer or group of buyers may enter, upload, or otherwise input data about an offer into a database. In similar fashion as sellers enter property data into a database, as described above, buyers may thus input various types of information needed or useful to make an offer to purchase a selected property. Buyers (and sellers) may also enter or be prompted to enter identifying data and offer-related data through a data structure.

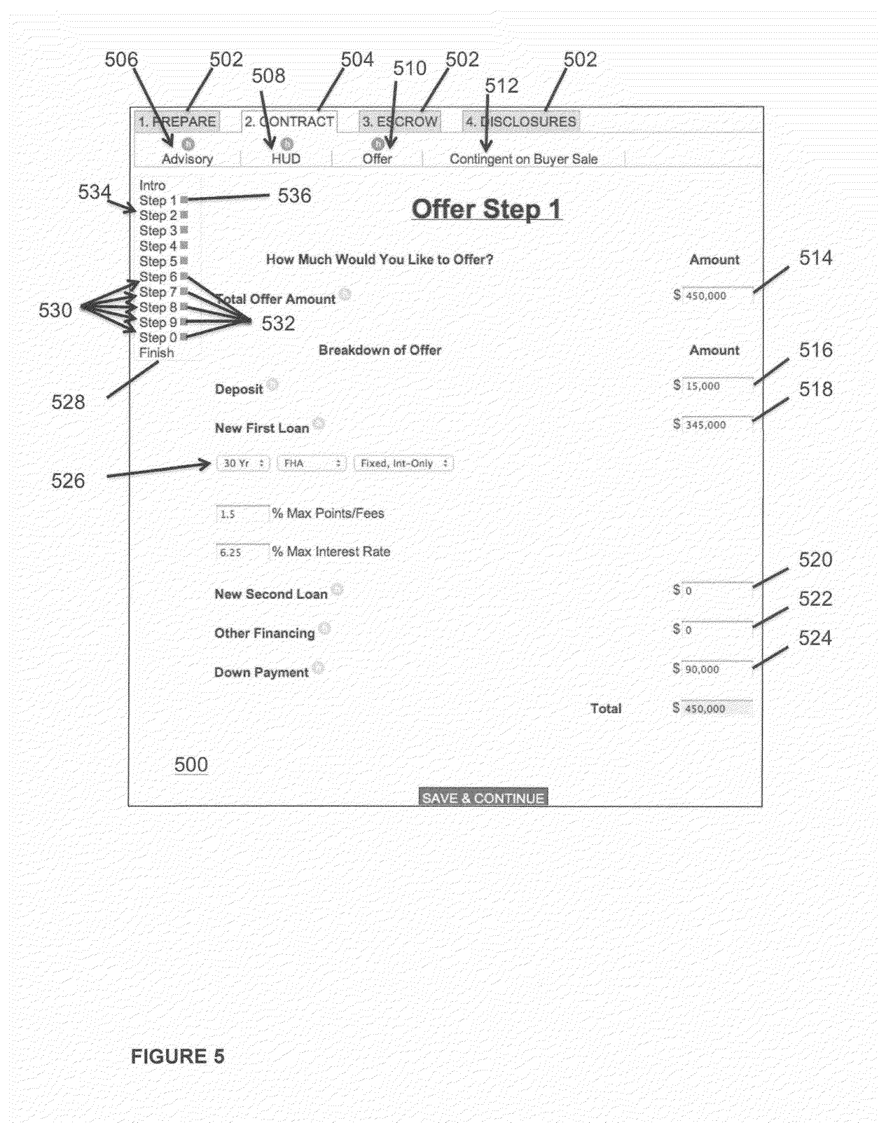

In an example illustrated in FIG. 5, a web page 500 is illustrated for a buyer to enter particular offer data. Web page 500 may include tabs 502 for a buyer to select a particular section of the offer and transaction process or purchase transaction sequence on which a buyer would like to work. Tab 504 is an exemplary tab labeled “CONTRACT,” which facilitates buyers' connection to a user interface for entering data concerning an offer. Tab 504 and each other tab 502 may include links that appear when the respective tab is selected. In FIG. 5, tab 504 appears as active, and thus links 506, 508, 510, 512 are displayed. As discussed above in connection with similar functionality on other exemplary web pages, since web page 500 is associated with link 510 (“Offer”), the area around link 510 may be highlighted or shaded, as a visual indicator that the “Offer” functionality associated with link 510 is currently active. Of course, as discussed above, other functionality may be employed to indicate that link 510 is active.

Tab 504 may also include several features and functionality related to generating and signing the actual purchase contract for the subject property. This may be a staged process, which a buyer may navigate through links 506, 508, 510, and 512 (although not necessarily in any particular order) in connection with making an offer and negotiating purchase contract terms. In addition, functionality may be included for automatic or manual generation of an actual purchase contract document. Such a document may be generated from a stored form or template that may be automatically or manually populated with information entered by the parties throughout the transactional process. Such forms and templates may be stored in a database, or retrieved from any other compatible media or storage. Forms and templates may include respective terms and conditions that may be applicable to or required in a particular jurisdiction or geographic area in which the subject real property is located. As the transactional process progresses through the offer, review, and any counter-offer stages, as described in greater detail below, completion of the purchase contract may continue to progress, and a complete contract document may thus be finalized for signature. The contract may be reviewed by the parties at various stages, and may be stored in the database as the transactional process proceeds, allowing content that is added to or populated in the contract to be saved, so that the contract process may be stopped and later continued at the point where it was stopped.

While the “Offer” functionality associated with link 510 is active, a buyer or buyers can enter a “Total Offer Amount” in field 514, and enter specific components of the “Total Offer Amount” in fields 516, 518, 520, 522, 524, which correspond to “Deposit,” “New First Loan,” “New Second Loan,” “Other Financing,” and “Down Payment,” as well as other fields that may be appropriate. Exemplary pull-down menus 526 may be useful for selecting specific terms corresponding to a mortgage or “New First Loan,” such as mortgage term and type of mortgage. Such items are often useful in transactions to establish or confirm a buyer's credibility and ability, or availability of resources to purchase property. In embodiments, any other information that may be useful in conveying an offer to a seller may be requested and input on such a page, and the information requested and entered is not limited to the examples described above. Once offer data and/or related information is entered by a buyer, it may be stored in a collection (e.g., a database) for ease of manual or automatic parsing, recall and extraction later when they may be needed in connection with a transaction, such as for populating offer sheets and other transaction documents with particular parameter values from the database, or providing selected items to sellers without having to enter the data again.

Since a large amount of buyer-specific data is required or suggested for a buyer to prepare and send an offer to a seller, the offer process may be broken down into a series of discrete steps, which a buyer can complete one at a time, or when the buyer receives relevant information. Embodiments may be configured to allow buyers to work on individual steps in an offer-building process, in no particular required order, then save their work and inputs until they can return at a later time to complete it. In fact, any and all of the data and information entered by a buyer, seller, related party, or third-party in connection with creating an account, listing a property, searching a property, making an offer, requesting or providing third-party or “a la carte” services, or any other functionality may be stored in a database for later retrieval.

In an embodiment, indicator window 528 may alert a buyer when particular steps are completed or if they require further attention. Indicator window 528 may enumerate a list of tasks 530 that correspond to data entry screens used in offer preparation and other related tasks to be completed by a buyer in connection with preparing and delivering an offer. Each task 530 may include a legend identifying the particular offer step with which it correlates. Indicators 532 may provide a quick visual reference regarding the completion status of the particular steps identified by tasks 530 in the indicator window 528. Indicators 532 may be configured to change color, shading, shape, or any number of quick visual parameters that may automatically change to a new, distinct visual parameter when the relevant data is entered and the associated step is completed or to convey other useful information. For example, task 534 corresponds to “Step 1.” Indicator 536 may be shaded or colored red to indicate that “Step 1” has not been completed. When the appropriate data is entered by the buyer, indicator 536 may change from red to green, for example, to provide a quick visual reference to the buyer that “Step 1” of preparing an offer has been completed. Alternately, if a buyer has entered some, but not all of the data called for by the fields in web page 500, the buyer can stop the process, store what he or she has entered, and move to another step, or exit the process completely, and return at a later time. In this case, indicator 536 may remain red until all of the data requested to complete “Step 1” is entered, at which time it may change to green. Of course, as with other indicators described herein, the functionality for indicating the status of a particular task or item is not limited to indicia described herein, but may include other visual and non-visual indicia that may provide an indication of the status or quickly provide other useful information.

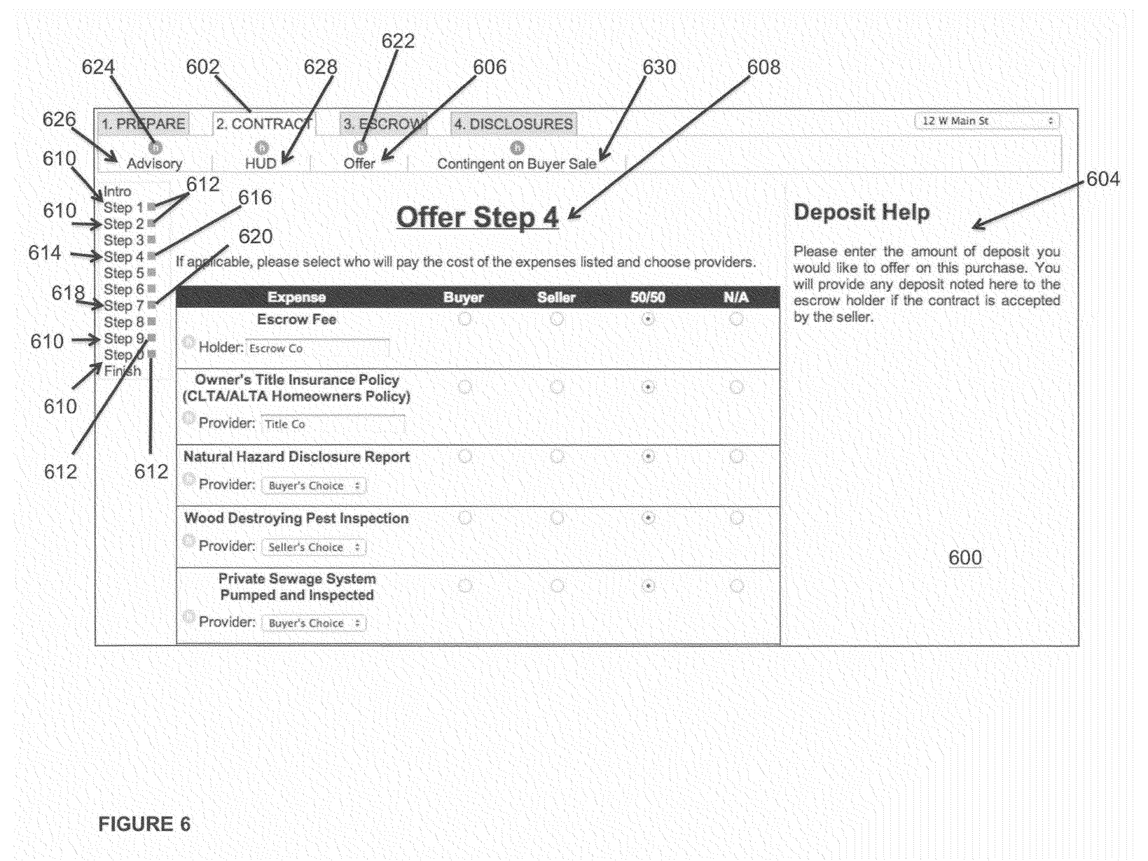

Another example of a step in a staged offer preparation procedure is depicted in FIG. 6. Web page 600 may be associated with Step 4 of an offer process. This page also is part of the “CONTRACT” process associated with tab 602. Web page 600, and other web pages utilized in embodiments of the process may include textual or graphic instructions 604. Instructions 604 may provide useful guidance, direction or other “help” to a buyer in preparing an offer. Similar textual or graphic instructions may be displayed on various web pages in embodiments, to provide similar guidance regarding the transaction process to buyers and other participants in the sale transaction process or purchase transaction sequence, such as sellers and third-party service providers. Referring again to FIG. 6, there is seen an “Offer” link 606, which navigates a buyer to the offer preparation process. As described in connection with analogous link 510 of FIG. 5, the area around link 606 may be highlighted, shaded, or display other visual indicia to indicate to a buyer that the “Offer” link 606 is currently active. As discussed above, the functionality indicating that link 606 is active is not limited to the indicia described herein, but may include any type of visually- or non-visually discernible indicia. Web page 600, and all web pages utilized in connection with embodiments, may further include a title 608, which informs a buyer that he or she is working on Step 4 of the “Offer” link.

As was discussed in the description of web page 500 (FIG. 5), web page 600 may include a list of tasks 610 with associated indicators 612. Indicators 612 may provide a quick visual reference regarding the completion status of the particular steps identified by tasks 610 or other useful information. As discussed in connection with other functionality described above, indicators 612 may be configured to change color, shading, shape, or any number of quickly discernible visual parameters that may automatically change to a new, distinct visual parameter when the relevant data is entered and the associated step is completed. For example, task 614 may be associated with indicator 616, which may be colored green to indicate that “Step 4” has been completed. In contrast, indicator 620, associated with task 618 may be colored red to indicate that “Step 7” has not been completed and needs further attention. In similar fashion, link 606 and other links used throughout the “Contracts” process, or any process employed in embodiments, may include an indicator 622 to provide a user with visual status indicia regarding whether the tasks, steps, information or procedures associated with that particular tab have been completed or need further attention. For example, indicator 622 may be colored red, to show a user that several steps have not been completed, as confirmed by tasks 610 and indicators 612. In an embodiment, once all steps associated with tasks 610 have been completed, indicators 612 may also change to a state indicating completion, and indicator 622 may change to a “completed” state. As discussed in connection with indicators 612, “incomplete” and “complete” states of indicator 622 may be designated by a particular color, shading shape, or other characteristic that provides a quick visual reference of the indicator state, and whether all associated tasks and procedures have been completed, and all relevant information has been provided. For example, indicator 622 may be colored red before all tasks associated with link 606 have been completed. When the tasks associated with link 606 are completed, indicator 606 may automatically change to green, and signal 624 may similarly be colored green at link 626 when the respective related tasks are completed. Link 606 may be colored yellow to indicate that a user has started the “Contracts” process, but not all steps and tasks have been completed. Of course, as discussed above, other visual- or non-visual indicators may be employed to indicate the status of various tasks and links in embodiments.

In similar fashion, a buyer may enter data related to other aspects of offer preparation, such as those referenced at links 626, 628, 630, under the “Contracts” tab 602, and labeled “Advisory,” “HUD,” and “Contingent on Buyer Sale,” respectively. For example, clicking on link 626 may access web pages, tasks, indicators, instructions and descriptions related to “Advisory” functionality and data. Each of these links reflects particular information that a buyer and seller may exchange in connection with an offer or transaction. Data entered in connection with any of these items, or at any stage of the transaction process or purchase transaction sequence may be stored in a database as parameter values for reference or retrieval in later stages of the transaction process, and all data entered by a buyer may be selectively shared with a seller, and parameter values may be manually or automatically populated in transaction documents, such as a sale/purchase contract, offer, counter-offer, counter-counter-offer, acceptance, disclosure, obligation, contingency, or any other document contemplated in embodiments as useful in connection with a real estate transaction.

In embodiments, a buyer may thus continue providing information, such as through web pages, until all required and helpful items have been provided and stored. A buyer may enter this data in any sequence, and switch between functions represented by links at any stage of the process. The use of indicators allows a buyer to keep track of the items that have been input, and which items may require further attention or information.

It is to be appreciated that embodiments may include form and template documents and contracts that are necessary or helpful in particular aspects of the transaction. For example, embodiments may include standard, generally accepted contracts for sale of real property within a given jurisdiction. Embodiments may also include other standard forms such as disclosures, escrow documents, offer sheets, counter-offers, listing sheets, and any other documents that are used in real estate transactions. The documents may be manually populated with related data, or, in embodiments, particular parameter values may be automatically parsed from the stored property data and transaction-related data, retrieved and populated or incorporated into such forms, templates and other documents directly from the database where it may have been entered or stored by the parties at various points and stages of the transaction process or purchase transaction sequence. Moreover, such form documents and templates may be input by the parties, or obtained for use in connection with embodiments through other sources of such documents. In embodiments, the parties may also be able to generate their own versions of documents, or generate custom documents for special aspects of transactions. In embodiments, form documents and templates may be stored in a database for parties to access, reference or populate with data and transmit to another party. Alternately, such form documents and templates may automatically be proposed for use by a buyer, seller or related third-party at various stages of the transaction process or purchase transaction sequence. Such functionality may allow the party to review and accept a document or template for use, reject the document, or manually edit the form document or template for use in the transaction. Electronic signatures and various other indicia for manifesting a party's assent, as described in greater detail, below, may be utilized in connection with such form documents and templates, to allow the parties to generate and/or approve actual contract documents.

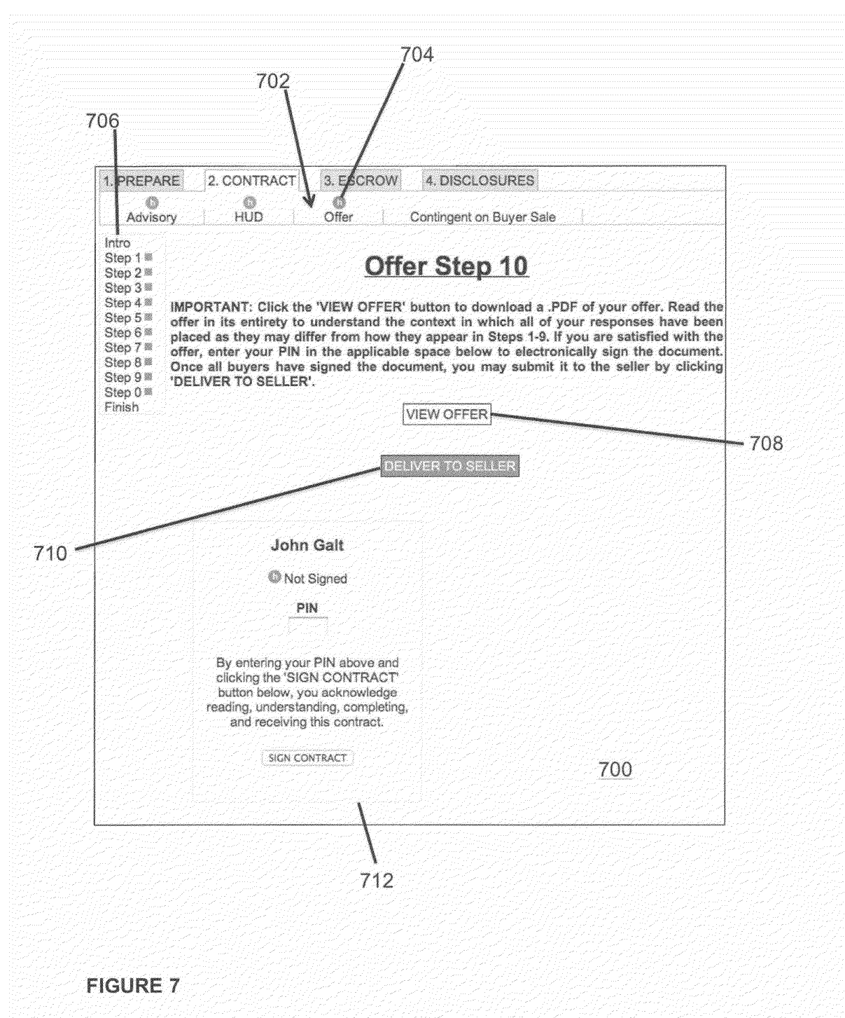

Returning now to FIG. 1D, when a buyer has entered and stored information and data required or helpful to submit an offer, an offer may be finalized for delivery to a seller, as shown at box 156. In an embodiment, and as seen in FIG. 7, a web page 700 may provide descriptions and instructions of how to complete an offer and deliver it to a seller. Link 702 (labeled “Offer”) may include indicator 704, which may be colored red, indicating that the buyer has not completed all the steps or entered the information requested in the “Offer” process. Specific completed and incomplete steps are shown in list 706. In embodiments, completion of all steps enumerated in indicator window 706 may not necessarily be required to advance a step in a contemplated transaction, or the transaction as a whole. Indeed, such lists may function simply as checklists or visual indicators to help a buyer keep track of steps that have been completed, rather than as requirements to proceed with the next stage of a transaction. Nevertheless, in embodiments, a buyer may be provided the opportunity to view web page 700 before completing all the steps enumerated in list 706, as it may be useful for a buyer to view a draft offer before it is sent to a seller. Button 708 may facilitate direct viewing or downloading of a file or document that corresponds to one that would be sent to the seller. This may quickly highlight to a buyer the information or data that still must be entered. Web page 700 may also include a button 710 which a buyer can click to deliver a copy of an offer to a seller when the buyer has finished preparing it. Embodiments may also include a signature window 712 on web page 700, where a buyer may input some indicia of his or her signature. Indicia such as PINs, special codes or passwords, or other electronic signature methods may be employed to facilitate a buyer's signature on the document in a way that assures a seller that the buyer has actually signed and furnished the document. At this steps, as throughout the offer generation and the entire transaction process, data and information entered by a buyer may be stored in a database for later retrieval and further use in a transaction process or purchase transaction sequence, such as communicating particular items to a seller or automatically or manually populating related transaction forms, as described in connection with various embodiments herein.

Referring again to subroutine 150 illustrated in FIG. 1D, a buyer may deliver an offer to a seller at box 156. A seller receives an offer at box 158 after it is sent by a buyer. In embodiments, a seller may be provided with access to view the offer unprompted, or may receive an automated notification that an offer has been sent. For example, a seller may receive such a notification via text message, email, social media, or other means of automated communication. The communication may include a prompt or directions indicating that an offer is ready to be viewed by the seller, such as on or through a web page, and how a seller may do so. It is to be appreciated that multiple offers from several buyers may be made for the same property. Indeed, embodiments may provide for data storage and tracking or items and tasks related of such multiple offers.

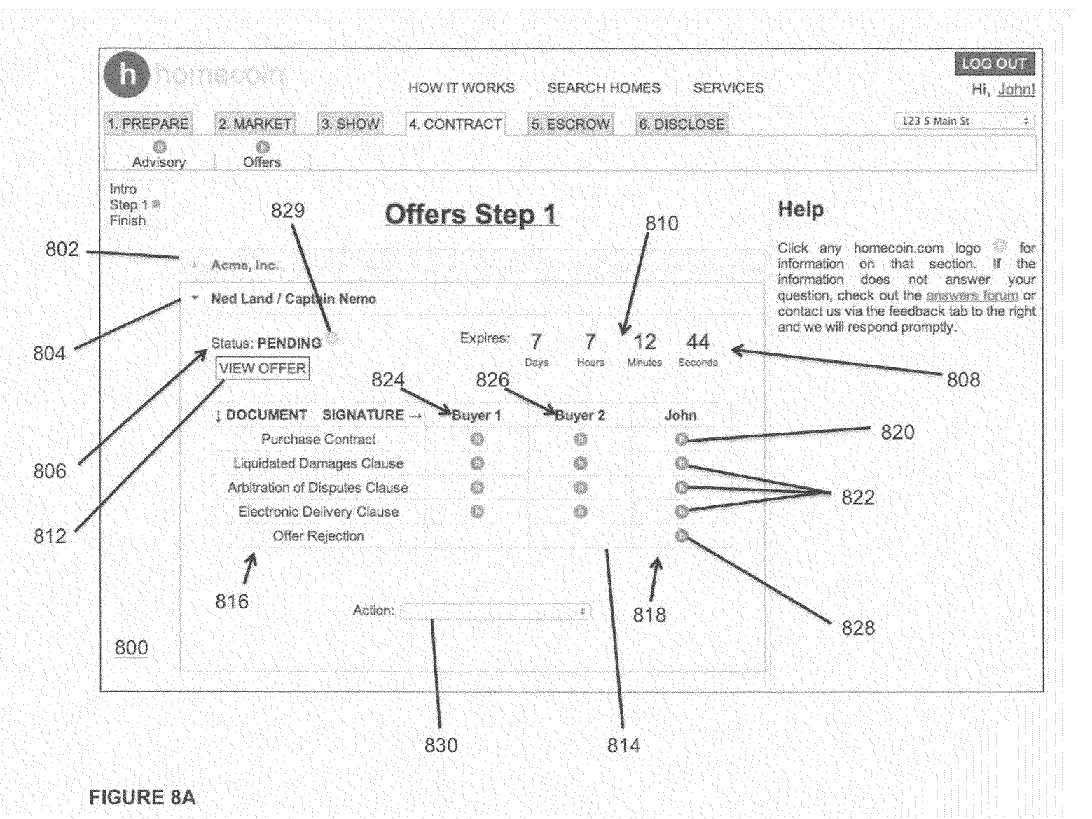

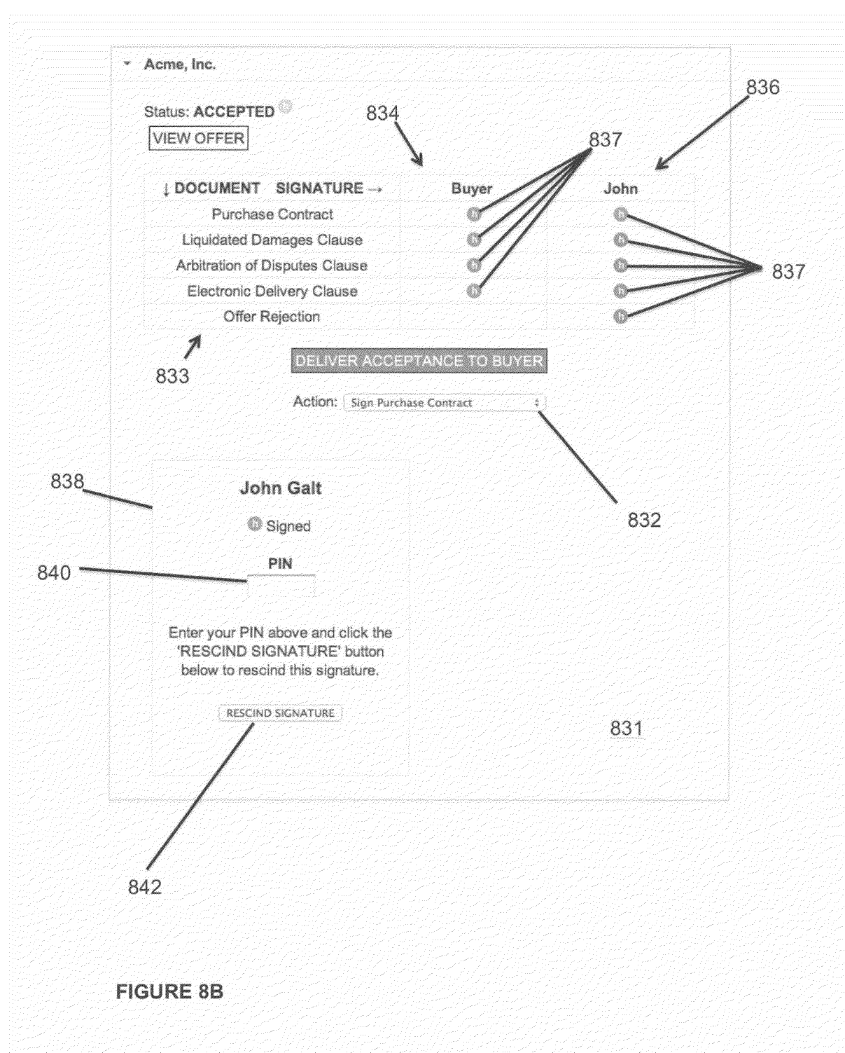

In furnishing an offer to a seller, a buyer may also specify a time of offer pendency. For example, FIG. 8A illustrates a web page 800 for buyers' and sellers' reference and information regarding offers that buyers have sent. Web page 800 may also include offer information pull downs 802, 804, which may function to expand and collapse when clicked, to alternately show and hide information regarding a particular offer. In FIG. 8A, offer informational pull-down 802 is shown in its “collapsed” configuration, while offer informational pull down 804 is shown in its “expanded” configuration. Each offer informational pull-down may include an offer status indicator 806 that displays the offer status (i.e., “pending,” as illustrated in FIG. 8A). Offer status indicator 806 may show whether an offer is pending or expired, or other status related to its pendency. Offer informational pull-downs 802, 804 may be configured to include the names of one or more buyers, respectively.

In expanded offer informational pull-down 804, field 808 may include or depict a running timer 810 that corresponds to the time of offer pendency specified by a respective buyer. Timer 810 provides a viewer of web page 800, such as a buyer or seller, for example, with a visual indicator of the time remaining to accept an offer before it expires.

Each offer informational pull-down may also include a “view offer” button 812, which may be configured to allow a seller to download and view an image of the offer document on a display screen or print a hard copy for review. In addition, each offer informational pull-down may include a buyer offer signature window 814. Buyer offer signature window 814 may be configured in various ways to provide a visual indicator to the parties regarding the signature status of an offer document as well as particular clauses that buyers and sellers may approve with a signature if included in the purchase contract. Such signatures or assent may be indicated through various means as described in greater detail above. It is to be understood that affixing a signature to such clauses may not necessarily form a binding agreement, but may serve to evidence a respective party's acknowledgment that such a clause has been included in an offer or purchase document. For example, buyer offer signature window 814 may include a column for each party that needs to sign an offer or related purchase contract for a sale transaction to become a binding obligation. Column 816 of buyer offer signature window 814 enumerates a “Purchase Contract,” “Liquidated Damages Clause,” and other clauses that require a signature or acknowledgment from each of the parties to the sale transaction. For each enumerated document or clause, there is a corresponding signature indicator associated with each relevant party. For example, column 818, corresponding to a seller, includes several signature indicators 820, 822, 828, each corresponding to a particular document or clause enumerated in column 816. Signature indicators may be configured to provide a quick visual indicator of the signature status regarding a particular corresponding document or clause. As discussed above, quick visual indicators may include color-based indicia, as well as shading, shape, or other characteristics that may change to indicate a particular state, such as “signed” or “unsigned.” For example, signature indicator 820 may be colored green to indicate a “signed” condition for the seller with respect to the purchase contract. Analogously, signature indicators 822 may be colored red to indicate an “unsigned” condition for the seller with respect its corresponding document or clause that requires signature. Similar signature indicators may be configured for each signature required from each buyer, such as “Buyer 1” and “Buyer 2” identified in columns 824 and 826. Furthermore, offer rejection signature indicator 828 may be configured in the bottom row of column 818 to provide a visual indication of whether a seller has signed an “Offer Rejection,” or whether an offer rejection is signed or remains “unsigned,” in similar fashion as indicators 820 and 822 indicate “signed” or “unsigned” status regarding corresponding documents or clauses. In fact, the functionality of indicators 820, 822 and 828 is not limited to the visually discernible indicia described herein, but may include other visual- and non-visual indicia, as described in connection with other functionality discussed herein.

Web page 800 may also include an “action” pull-down menu 830, that may be configured to launch another window or view that may allow either party to affix signatures to the various documents and clauses enumerated in buyer offer signature window 814. For example, by selecting an option from pull-down menu 830 such as “Sign purchase contract,” the buyer identified in pull-down 802 (“Acme”) may access or launch functionality to affix signatures, as described in greater detail, below.

FIG. 8B illustrates the expanded configuration of buyer offer signature window 831 that corresponds to offer informational pull-down 802 (FIG. 8A). In similar fashion as displayed in connection with buyer offer signature window 814 (FIG. 8A), a visual indicator may be provided in buyer offer signature window 831 regarding the signature status of an offer document as well as particular clauses that may require additional signatures. Buyer offer signature window 831 may include a pull-down menu 832 that facilitates access to functionality through which a buyer may review the documents and clauses enumerated in buyer offer signature window 814 (FIG. 8A), and affix signatures or other indicia of assent, similar to those described in greater detail above. Buyer offer signature window 831 may also include a column 833 listing particular documents and clauses to which a signature may be affixed, as described above in connection with offer signature window 814, as well as columns 834, 836 that include signature indicators 837 which may be configured to provide a quick visual reference of whether a party has signed a particular document or clause. In contrast to buyer offer signature window 814, which includes separate columns 824, 826, one for each of two buyers, offer signature window 831 may be configured to include only a single signature column 834, corresponding to a single buyer associated with the respective offer. As with other visual indicators described herein in connection with embodiments, quick visual indicators may include color-based indicia, as well as shading, shape, or other characteristics that may change to indicate a particular state, such as “signed” or “unsigned,” for example. Moreover, signature indicators 837 are not limited to the particular examples described herein, but may include various other visual- and non-visual indicia.

In an embodiment, functionality may be included to verify that all required signatures have been made prior to delivery of any respective document. If all required signatures have not been affixed to any such document, an error message may be displayed so that the omitted signature may be affixed or other appropriate action may be taken, such as termination of a pending offer if all required signatures have not been affixed before an offer expired, for example.

Buyer offer signature window 831 may also include a rescind field 838 that facilitates a seller's rescinding of a previously provided signature. Before a seller signs all required documents and clauses and transmits notice of acceptance to a buyer, the seller may rescind a particular signature. A seller may do so by inputting some indicia of his or her signature in window 840. Indicia such as PINs, special codes or passwords, or other electronic signature methods may be employed to facilitate rescinding a seller's signature, as described above in connection with other embodiments. In an embodiment, after entering a particular required indicia of signature, a seller may click on “rescind signature” button 842, to finalize the signature rescinding process. The rescind signature process may be configured to separately facilitate rescinding of each signature provided by a seller in column 836, or by a buyer in column 834.

Returning again to FIG. 1D, at decision diamond 160, a seller may elect to accept or reject the offer. If a seller accepts the offer, signatures may be provided as described in connection with embodiments that facilitate signature, above, and subroutine 150 may be exited as seen in FIG. 1D, at button 176. Process 10 may be resumed at button 26 and subsequently diamond 28, as seen in FIG. 1A.

However, in addition to simply providing for transmittal of an offer from a buyer to a seller, and for a responsive acceptance of the buyer's offer by the seller, embodiments may facilitate rejection of offers by sellers, proposal of counter-offer by seller, as well as acceptance of counter-offer, proposal of further counter-offer, or cancellation of offer by buyer. As seen in FIG. 1D, if a seller rejects an offer at decision diamond 160, a seller may decide whether to finally reject the offer, or to transmit a counter-offer to the buyer, as seen at decision diamond 162. If the seller decides to finally reject the offer, subroutine 150 may be exited, as seen at button 176, and process 10 may be resumed at button 26 and subsequently diamond 28, as seen at FIG. 1A, from where process 10 may subsequently be terminated, as seen at termination button 42. A seller may be able to communicate or transmit a rejection to a buyer in several ways, such as by clicking a button on a webpage, for example, before the seller has signed all documents and clauses as described above. As with other features described herein, a buyer may be notified of such rejection through various functionality, such as email, text message, or other communication methods.

If, however, a seller decides to transmit a counter-offer, the seller may enter respective information for preparing a counter-offer at box 164, and the counter-offer is submitted to a buyer at box 166. Where a seller chooses to propose a counter-offer to a buyer, a seller may utilize functionality provided in embodiments to input and store data pertaining to the counter-offer terms such as in a database, for example, and transmit notice of the counter-offer to a buyer.

In embodiments, a buyer may then consider whether to accept the counter-offer at decision diamond 168. If a buyer rejects an offer at decision diamond 168, a buyer may decide whether to finally reject the offer, or to transmit a counter-offer to the seller, as seen at decision diamond 170. If the buyer decides to finally reject the offer, subroutine 150 may be exited, as seen at button 176 and process 10 may be resumed at button 26 and subsequently decision diamond 28, as seen at FIG. 1A, from where process 10 may is terminated, as seen at termination button 36. A buyer may be able to communicate or transmit a rejection to a seller in several ways, such as by clicking a button on a webpage, for example, before the buyer has signed all documents and clauses as described above. As with other features described herein, a seller may be notified of such rejection through various functionality, such as email, text message, or other communication methods.

On the other hand, a buyer may simply accept the seller's counter-offer at decision diamond 168, and notify the seller; and signatures may be provided as described in connection with embodiments that facilitate signature, as discussed above. In such a case, subroutine 150 may be exited as seen in FIG. 1D, at button 176, and process 10 may be resumed at button 26 and subsequently decision diamond 28, as seen in FIG. 1A.

Alternately, a buyer may decide to submit a counter counter-offer to a seller at decision diamond 170. If, a buyer decides to transmit a counter counter-offer, the buyer enters respective information for preparing a counter-offer at box 172, and the counter-offer is submitted to a seller at box 174. Where a buyer chooses to propose a counter counter-offer to a seller, a buyer may utilize functionality provided in embodiments to input and store data pertaining to the counter-offer terms such as in a database, for example, and transmit notice of the counter-offer to the seller.

As shown in FIG. 1D, iterations of offers and counter-offers may continue with respective parties inputting and storing additional data for transmittal of viewing by the parties, until a party rejects an offer. In addition, either party may cancel a pending offer or counter-offer before it is accepted by the other party. Of course, the inputting and storage of relevant offer and counter-offer information during these iterations, as well as during the review and signature processes, may proceed as described above in connection with preparation, transmittal and review of an “original,” or first offer. Furthermore, iterations of offers and counter-offers, as well as offer cancellation may incorporate expiration timers and may require signatures or inputting some validation or indicia of a party's signature. Visual status indicators, such as those described above, for example, may be incorporated into the offer and counter-offer functionality to permit the parties to monitor and track completion and signature status regarding particular documents, clauses and broader aspects of the transactions (as described above, such indicators are not limited to the examples described herein, but may include other types of visual and non-visual indicators). Of course, data that is transmitted between buyers and sellers in each offer-counter-offer iteration may also be stored in a database for ease of retrieval and later use in further buyer-seller communications or in documents and communications related to closing the transaction. Various embodiments may thus facilitate communications between buyers, sellers, and other parties.

Returning now to FIG. 1A, as seen at decision diamond 28, if the parties have agreed to move forward with a transaction for a relevant property, an acceptance notice may be delivered to the buyer or buyers. In an embodiment, delivery of acceptance notification to a buyer or buyers may occur regardless of whether the final offer or counter-offer was made by the buyer(s) or seller(s), and the buyer may be required to sign the final acceptance before the seller does. For example, where a seller has received multiple offers and responds with multiple counter-offers, each buyer may respond with a signed acceptance which only becomes a completed transaction between the buyer and seller after the seller finally counter-signs it as seen at box 32. When such an acceptance message is communicated and counter-signed, as shown at boxes 30 and 32, the transaction may move into the closing phase. In the closing process, tasks required for closing may be identified as shown at box 34. After the task list is generated, parties may complete tasks or submit required information, as will be described in greater detail below. Completion of tasks and submission of respective information may be “tracked,” as seen at box 36, and also described in greater detail, below.

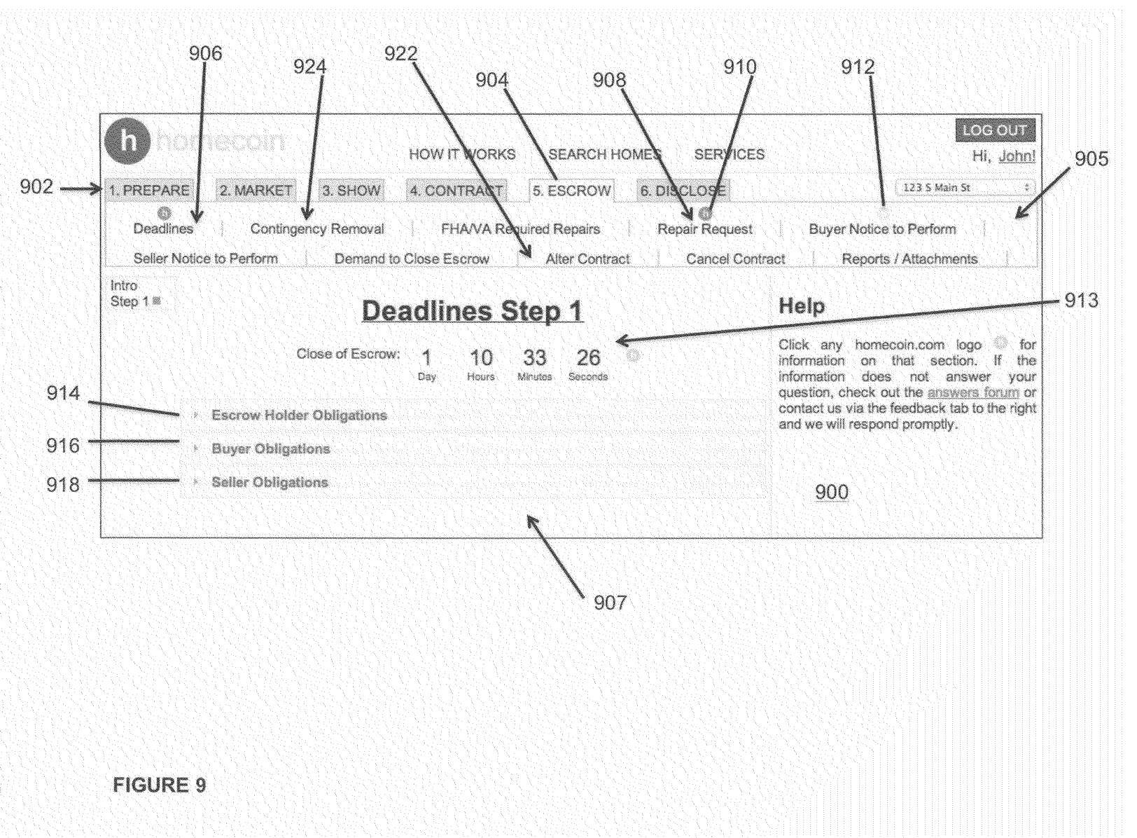

In real estate transactions, closing is often characterized by the deposit of funds and documents into an escrow account during the time between acceptance of an offer, and settlement or closing of the transaction pending completion or fulfillment of all outstanding obligations and contingencies. For example, FIG. 9 illustrates an exemplary web page 900, configured to provide a visual display of outstanding obligations or contingencies of each party to the transaction, namely buyer, seller and escrow holder. In the same manner as the “Prepare,” “Market,” “Show,” and other tabs arranged in tab display window 902 provide links to respective functions, clicking on Escrow tab 904 may activate links and status markers in escrow window 905 for items to be completed in order for the transaction to close. In an embodiment, escrow window 905 may be viewable by buyers and sellers, thus enhancing transparency of negotiations with respect to transaction-related information. The links appearing in escrow window 905 may include, for example, “Repair Request,” “Buyer Notice to Perform,” “Seller Notice to Perform,” “Alter Contract,” and others items that are appropriate for a particular transaction. Moreover, tab 904 may include other functionality within escrow window 905, such as links that launch or access functionality for generating contract alteration documents, submitting a notice to perform, and canceling a contract, for example.

For example, clicking on link 906 (“Deadlines”) may launch or provide a user with access to obligation window 907. As illustrated in FIG. 9, and as described regarding other features and functionality disclosed herein, link 906 may be highlighted, shaded or characterized by some other indicia to indicate that it is the currently-active link, and that the related information displayed on web page 900 is related to link 906. Obligation window 907 may be automatically populated with appropriate obligations and contingencies based on communications between buyer and seller and data stored in the data structure over the course of property marketing, showing, and the contracting process between buyer and seller. In embodiments, the items in obligation window 907, as well as the items associated with the other individual links found in escrow window 905, may be customized by a buyer and a seller to meet specifically tailored transaction requirements. Furthermore, additional items may be added to obligation window 907, or to any of the other respective individual links found in escrow window 905 by a buyer, seller or other third-party involved in a transaction or providing related services, such as an escrow agency or mortgage company, for example. Such additional items may be generated manually by a party, or may be included automatically as issues arise during the course of escrow. Escrow window 905, and associated links may thus provide enhanced transparency by allowing each of the parties and related service providers to view and be informed of the status regarding obligations and contingencies, as well as the others' related performance, without having to inquire. It is to be appreciated that embodiments may allow third-parties involved in a transaction or providing related services, to login and access certain information and content regarding a particular transaction. Such third-party access may be controlled and limited as desired by the seller(s) and buyers(s) to the limited information needed to perform a respective third-party's function in connection with the transaction.

In addition, respective documents, as well as forms and templates, may be offered, accessed, or populated for use in connection with obligations and disclosures, as discussed above in connection with other functionality. For example, these may include various respective standard forms, templates, checklists and other documents, which may meet certain local requirements or customs.

Obligations and contingencies in escrow window 905 may be associated with indicators that display whether a particular item is open, has been completed, or requires attention. For example, link 908, corresponding to a “Repair Request,” may be associated with indicator 910, which provides a visual reference as to the status of the “Repair Request” item. Clicking on link 908 may also lead a user to a visual copy of an actual “Repair Request” document or checklist, for reference. Returning to the discussion of indicators, indicator 910 may utilize color, shading, shape, or some other indicia as discussed in connection with other indicators described above, that serves to indicate the status of the corresponding obligation of contingency. For example, status marker 910 may be colored red to indicate that “Repair Request” is open and has not been completed. In contrast, status marker 912 may be colored yellow, to indicate that its associated obligation or contingency, “Buyer Notice to Perform,” requires attention or further input is needed in order to continue progressing to completion. In an embodiment, and as with other similar functionality described herein, buyers and sellers may input data and information relevant to the respective contingency via a graphical user interface or other input-enabling functionality. In the exemplary web page 900, each status marker may change to green once all information and inputs required for the respective obligation or contingency have been input. This indicates that the respective obligation or contingency is then considered “complete.” When all status markers are displayed as “complete,” the entire “Escrow” process may be considered completed, and the transaction may move to closing. Of course, not every link (e.g., link 906) corresponding to a respective tab (e.g., tab 904) may be relevant or appropriate for a particular transaction. In such a case, the respective links may be disabled and status markers may not be displayed in connection with such links and respective contingencies. As an additional note, data and information that is input in the course of fulfilling each of the contingencies may be stored in a database for communication to other parties in the course of the transaction, and for populating documents or data fields in other transaction stages, alleviating the need to re-enter the respective data.

Web page 900 may also include a countdown timer 913 that starts at a predetermined time and illustrates the time remaining until the escrow completion deadline. If particular obligations or contingencies remain open at the escrow completion deadline, the deal may be terminated and the escrowed items disbursed to their owners without changing hands. Web page 900 thus provides a way of quickly discerning the completion status of the various items associated with links under respective tabs, and how much time remains for them to be fulfilled in order for the transaction to continue moving forward to closure.

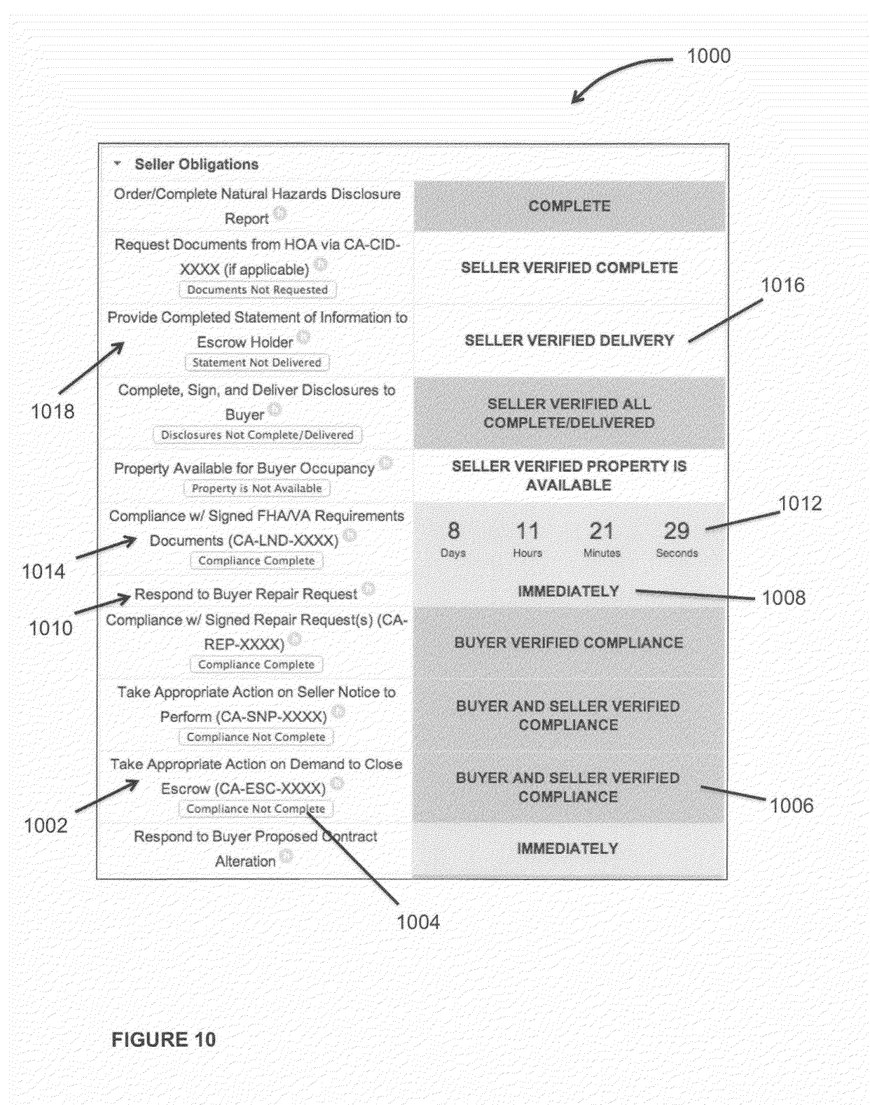

In an embodiment, further detail regarding the specific obligations and contingencies of the parties in connection with the escrow process may be accessed through pull-downs 914, 916, 918, corresponding respectively to “Escrow Holder Obligations,” “Buyer Obligations,” and “Seller Obligations,” within obligation window 907. For example, clicking pull-down 918 may expand or launch a seller's obligation roster 1000, as seen in FIG. 10. Similar respective obligation rosters for “Buyer” and “Escrow Holder” may be expanded by clicking pull-downs 916 and 914. Seller's obligation roster 1000 may include items for which the seller has primary responsibility, those for which the buyer has responsibility, and those for which seller and buyer share responsibility. Sellers' obligation roster 1000 may also include a visual status indicator that provides a quick reference as to whether any particular item has been completed or needs attention. For example, item 1002, labeled “Take Appropriate Action on Demand to Close Escrow,” may be associated with a status indicator window 1006. Status indicator window 1006 may display a message regarding the status of item 1002, and incorporate a readily-identifiable status indicia such as color, shading or even shape, which provides an immediately informative quick reference as to whether the item has been completed, is incomplete, or requires some other sort of attention or data input. Status indicator window 1006 may be colored green, for example, and as shown in FIG. 10, bear the message “Buyer and Seller Verified Compliance,” to quickly indicate the status of item 1002. In contrast, status indicator window 1008 may be colored red and, as shown in FIG. 10, and bear the message “IMMEDIATELY,” to quickly readily that action is needed quickly. In addition to exhibiting a visual indicia, such as being colored red, status indicator 1012 may display a timer to provide a quick visual reference of the time within item 1014 must be completed. Status indicator 1016 may be colored yellow and bear the message “SELLER VERIFIED DELIVERY,” to indicate that item 1018 may have been started but is awaiting further data input or action from a party.

Moreover, item 1002 may include a button 1004 that may be configured to allow a seller to take action to change the status of status indicator window 1006. For example, a seller may click button 1004 to launch or access functionality that allows seller to provide an electronic verification, or to complete any required action needed to complete item 1002. Verification or completion by seller may trigger an automatic notice, such as those described above, in connection with signature notification functionality, to a buyer that the seller has completed the respective item or verified the item as complete. With respect to items requiring verification from both parties, the procedure may be similar, except that the status may not indicate “completed” until both parties have verified compliance, for example.

As will be discussed in greater detail, below, similar types of obligation rosters and status indicators may be configured for buyer and escrow holder. Of course, the particular items in the roster may overlap and require input from multiple parties. In addition, such rosters and status windows may be configured with connections to the database of information and communication provided by buyers and sellers in the course of the preparing, marketing, showing, and negotiating activities that take place in connection with a real property transaction. Such connections may provide for the automated activation of particular obligations and links thereto, depending on whether certain transaction parameters have been fulfilled. The connections may also provide for storage, in the database, of information entered by the various parties to the transaction. Furthermore, information that is communicated or input in the course of addressing the various items on the obligation rosters may be captured by the database for manual or automatic recall later to facilitate other aspects of the transaction or populate data fields of relevant forms, or even the automated selection and proposal of form documents appropriate for a particular transaction. This provides the dual benefit of avoiding redundant data entry and reducing the number of opportunities for input errors. Thus, in embodiments, a comprehensive vault of information may be compiled and stored at each stage of a real property transaction, from its very first stages, for use as the transaction continues.

Referring again to FIG. 9, in similar fashion as link 906 may launch or provide access to a list of obligations, contingencies and associated tasks, other links in contingency window 905 allow a user to access other functionality associated with the “Escrow” phase of a transaction. Fulfilling these obligations and contingencies may require the completion of various associated tasks by the buyer and seller. In an embodiment, link 922 (“Alter Contract”) may launch or access functionality that allows a buyer or seller to propose a contract alteration, have a related alteration document generated, sign the alteration document, and deliver it to the counter-party. In similar fashion as described above in connection with other functionality, such a document may be automatically proposed, retrieved or generated, and populated with relevant parameter values parsed from data that has been entered in earlier stages of the transaction. A visual indicator (not shown in FIG. 9), but similar to indicator 910, may appear when a party has an alteration document generated in this way. Of course, such an indicator may appear in many forms, or utilize various indicia to indicate status, as discussed above. For example, in an embodiment, such an indicator may be displayed, and colored yellow, when an alteration document is generated, indicating that further work is needed in connection with this alteration document. The indicator may be configured to appear only to a seller at this stage, when he or she is logged in under his or her own access credentials (i.e., it may not be visible to a buyer logging in under his or her own access credentials and viewing web page 900). When an alteration document is signed and delivered, the visual indicator may disappear from the seller's view of web page 900, and appear on a buyer's view. That is, in a view visible only to a buyer, the visual indicator may be configured to appear red, or bear some other indicia that indicates a pending change to the sale contract.

In an embodiment, submission of an alteration document as described above may add an obligation to a party's obligation list (in this case, the buyers'). In similar fashion as pull-down 918 expands a list of “seller obligations,” pull-down 916 may expand a list of “buyer obligations,” which may enumerate such additional obligations added during the course of the transaction. If buyer(s) and seller(s) are in agreement with the alteration, any such new obligation would thus appear in the list of buyer's obligations, and each party may have the opportunity to verify its respective compliance, as described in connection with completion or verification of obligations enumerated on seller's roster 1000 (FIG. 10).

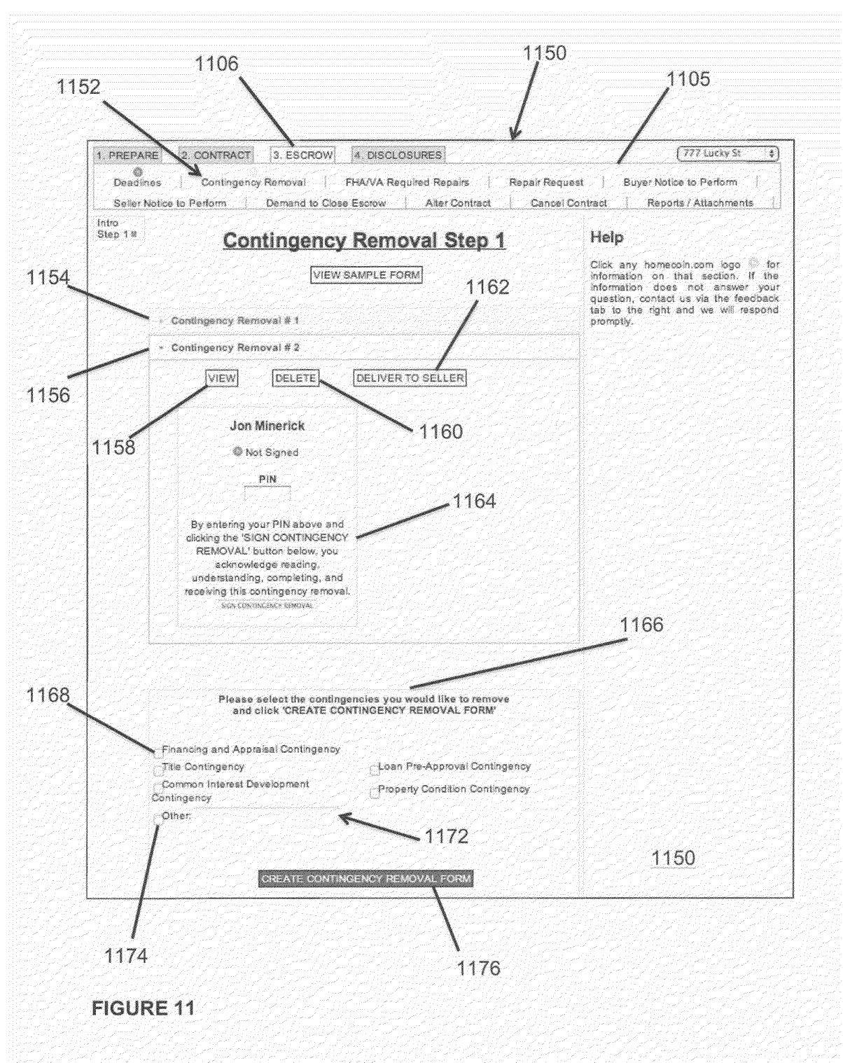

Referring again to FIG. 9, link 924 (“Contingency Removal”) may include functionality that allows buyers and sellers to remove particular contingencies to which they have agreed in the sale contract. In an embodiment, a list of contingencies may be partially or entirely generated automatically, based on negotiation data and transaction parameters entered by either party, or otherwise gathered, as a buyer and seller proceed through the various phases or steps of a purchase transaction sequence. Alternately, the parties may manually add to, or otherwise modify the list of contingencies. For example, link 924 may allow buyers and sellers to launch or access a list of contingencies, each associated with a signature block or other functionality for indicating agreement with a particular contingency. An example of a web page 1150 configured with such functionality is shown in FIG. 11. Web page 1150 may include escrow window 1105 (analogous to escrow window 905, as described in FIG. 9), associated with “Escrow” tab 1106, which may include a link 1152 (“Contingency Removal”). Associated with link 1152 may be contingency removal menus 1154, 1156. Contingency removal menus 1154, 1156 may include functionality allowing them to be expanded or contracted by clicking on the menu itself. In FIG. 11, contingency removal menu 1156 is shown in its expanded configuration, while contingency menu 1154 is shown contracted. In its expanded configuration, contingency removal menu 1156 may include buttons 1158, 1160, 1162, corresponding to “View,” “Delete,” and “Deliver to Seller” functionality, respectively. By clicking on a button associated with a desired action, a party may thus view (button 1158) or delete (button 1160) a contingency. A party may also deliver a contingency to the other party, as facilitated by the “Deliver to Seller” button 1162, for example. In order to remove a contingency and allow a transaction to proceed to the next stage, the parties may be required to provide a signature or other form of acknowledgment or assent. In an embodiment, signature window 1164 may be provided for this purpose. Signature and assent functionality has been discussed with other features described herein, and many types of signature/approval verification functionality may be utilized in embodiments.

Embodiments may also include functionality for generating contingency removal forms. As illustrated in FIG. 11, window 1166 may be provided on web page 1150 for such a purpose. For example, the various contingencies associated with a particular transaction may be enumerated in window 1166. Each contingency may be associated with a checkbox 1168, which the party generating the contingency removal form (typically the seller) may check when the party is satisfied that the contingency has been appropriately removed. Moreover, an additional input field 1172 and associated checkbox 1174 may be provided for the input of additional contingencies that may not have been automatically generated based on the transaction parameters, or which may refer to some other contingency that was discussed and agreed among the parties.

After a party has checked the contingencies it is ready to remove in window 1066, it may click button 1176 to generate a contingency removal form. The removal of contingencies may thus be recorded and stored in a database, and a form may be sent to the other relevant parties, indicating that the particular contingencies are removed. As discussed above, the contingency form may be transmitted via email, or a recipient may be notified by some other means, such as email, text message, or instant message, for example, that a contingency removal form has been completed by the other party and is awaiting review or reference. Furthermore, when buyer or seller indicates and submits its signed agreement that a particular contingency has been satisfied and may be removed, whether individually or as part of a “bulk” contingency removal of several contingencies contemporaneously, the indicator associated with any such contingency in seller's obligation roster 1000 (FIG. 10) and buyer's obligation list may automatically change to a green color, or exhibit whatever indicia is employed to provide notice to a viewer that such contingency has been satisfied and removed. When all contingencies are removed, the transaction can proceed to the next phase.

In real estate transactions, the escrow phase may also include the transmittal and review of various disclosures that a seller is required to provide a buyer. Several of these are required by law or regulation, and in embodiments may be required at various stages of process 10 described in FIG. 1A, even before the parties agree to move forward with closing and before the escrow process is started. Any related tasks and corresponding progress tracking with respect to disclosures may occur as described in connection with various embodiments described herein.

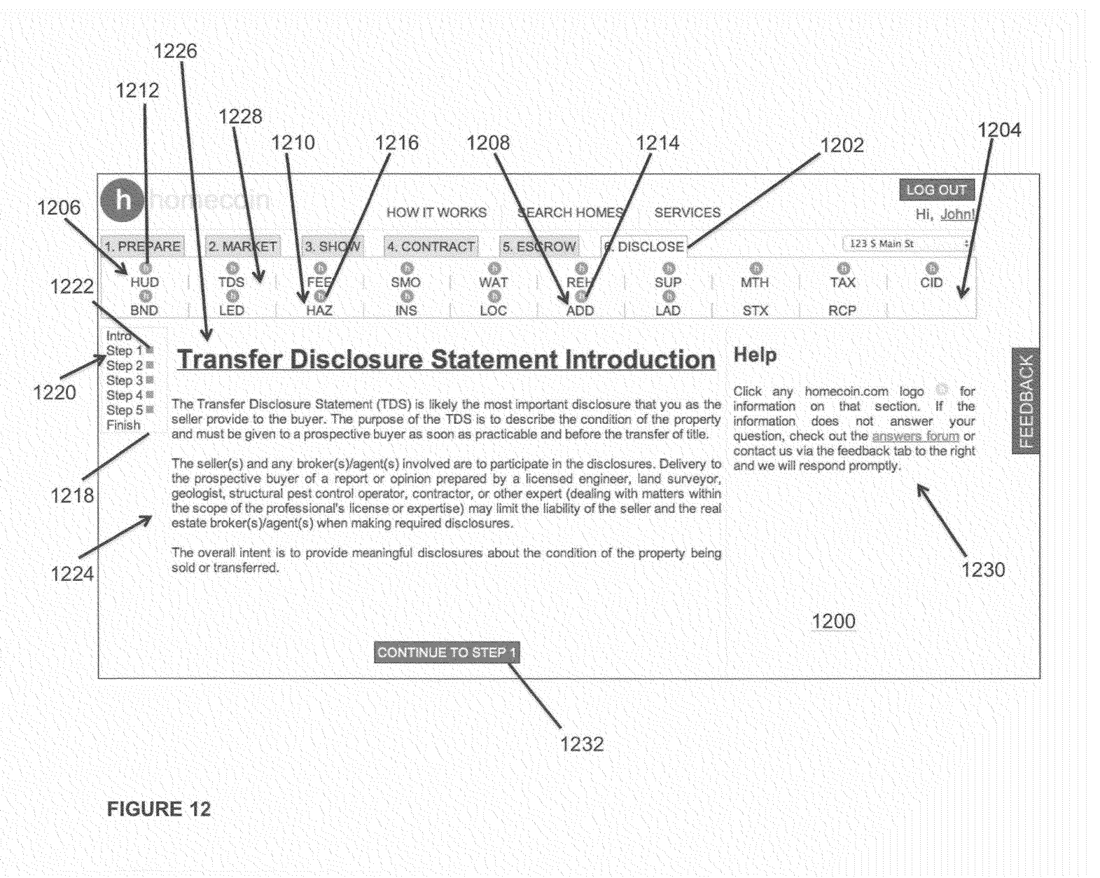

As seen in FIG. 12, in an embodiment, an exemplary web page 1200 may be configured to be accessible by buyers and sellers through tab 1202 labeled “Disclosure.” Disclosure field 1204 may enumerate each of the particular disclosures associated with a particular transaction. Disclosure field 1204 may also include links to copies of the documents that may be manually or automatically generated or populated as described in connection with other embodiments and which may be viewable, transmittable, and printable. For example, disclosure field 1204 may include disclosure links 1206, 1208, 1210, each corresponding to a particular disclosure document such as “HUD,” “ADD,” and “HAZ,” respectively. These acronyms are provided as examples only, of short, quickly recognizable abbreviations for particular disclosure documents. In embodiments, such documents may be referred to by any suitably useful name or abbreviation in connection with links 1206, 1208, 1210. Disclosure links may also include status indicators of the type described in connection with other similar functionality described herein. For example, indicators 1212, 1214, 1216 may correspond to disclosure identifiers 1206, 1208 and 1210. Status indicators may include visual and non-visual indicia such as color, shading or shape that can change as the respective status of the associate disclosure identifier changes. As an example, in FIG. 12, indicators 1212 and 1214 may be colored green, indicating that their respective disclosure links 1206 and 1208 have been completed and need no further work before continuing to the next stage of the transaction. On the other hand, indicator 1216 may be colored red, indicating that its respective disclosure identifier 1210 has not been completed and that the transaction may not be able to proceed before such items are completed.

As with other similar functionality described above, the “Disclose” functionality accessed through tab 1202 may be configured to allow manual entry or automatic population of form or template disclosure documents that are stored in the database (or which are entered or generated by users), with information and data that has been communicated between the parties or input throughout the transaction process or purchase transaction sequence by the buyer, seller and other parties, and gathered in a collection (e.g., a database); or with other relevant information and data. Such documents may be automatically generated and populated with relevant data and information parsed and extracted from the collection, and they may be made accessible to the relevant parties to provide additional needed information or perform additional required actions to close out the particular respective aspect of the transaction (i.e., finalizing a particular disclosure).

In an embodiment, disclosure documents may be completed, electronically signed and electronically delivered, before being viewable by the receiving party. Often, the seller is the originating party. Regardless, however, in an embodiment, the originating party may access functionality helpful in generating a disclosure document. This may include functionality that allows review and selection of appropriate templates or forms. Alternately, form documents may be proposed for the originating party's review and finalization. In either case, as with functionality described in connection with purchase contracts and contingency forms, disclosure forms or sections thereof may be automatically or manually populated with data stored by the parties in the database throughout the course of the transaction or with other relevant information. Once generated, the originating party may affix a signature to the disclosure document, as described in connection with other features and functions herein. The disclosure document may be transmitted to the other party for viewing upon signature, or only after the originating party takes some affirmative action, such as clicking on a “send” or “deliver” button, for example. In an embodiment, buyers and sellers may have individualized access to web page 1200, which provides each party with the respective information needed to understand the status and the actions required to review and sign or otherwise acknowledge the disclosure. For example, disclosure field 1204, as illustrated in FIG. 12, represents a “seller's view,” which may differ from a web page or a view made accessible to a buyer. The status indicators illustrated in FIG. 12, including indicator 1216, may be colored red, indicating that they are incomplete. In a view of web page 1200 that is accessible to a corresponding buyer (not shown), many of the corresponding disclosure identifiers may not necessarily display an associated status indicator until a disclosure is delivered to the buyer. This is because the receiving party (buyer, in this example) would have no action to take until the other party (seller, in this example), completes and delivers a disclosure document to the buyer.

In an embodiment a completed disclosure may be electronically transmitted to the receiving party, along with some sort of notice, such as an email or other such notice described herein in connection with similar functionality, for example, indicating that a disclosure is ready for viewing by the receiving party. As with other functionality described herein, a recipient may access a web page such as web page 1200 when notified of a disclosure. The recipient may see an associated status indicator displayed with a disclosure link, indicating that action is required. For example, the status indicator may exhibit some sort of indicia, such as being colored yellow, for example, indicating that action is needed. The user may then click on a link associated with the disclosure identified to view the disclosure. Upon review, the receiving party may affix a signature or utilize other functionality, as described in connection with other features described herein, to verify the receiving party's authorization and “signature” of the respective disclosure document. When signed, notice of the recipient's acceptance may be transmitted to the originating party automatically upon signature, or only after the receiving party takes some affirmative action, such as clicking on a “send” or “deliver” button, for example. In conjunction with transmittal of the receiving party's acceptance to the originating party, an additional notice, such as an email, instant message, or other such notice described above in connection with similar functionality, for example, may be delivered to the originating party, indicating that the disclosure has been reviewed and signed.

As each disclosure is generated, delivered, reviewed and signed, the status indicator associated with each such disclosure may change to display some indicia on buyers' and sellers' individual views of web page 1200, that the associated disclosure has been completed. For example, such status indicators may change to a green color in this case.

Furthermore, web page 1200 may include an indicator window 1218 that includes tasks such as task 1220 (“Step 1”) and indicators such as indicator 1222. Task 1220 may describe a particular segment or step of a broader process such as the “Disclosure” functionality accessed through tab 1202. Indicators such as indicator 1222 may be configured to change color, shading, shape, or incorporate any type of quickly-discernible indicia that provides a readily-discernible signal to a user when the status of a step or segment associated with a respective associated task 1220 changes, such as from “incomplete” to “complete.” Of course, as described above, such indicators may be configured to provide such status information and other information utilizing various types of visual or non-visual indicators.

Message field 1224 of web page 1200 may include a description of a particular disclosure document accessed by tabs such as tab 1202. In addition to a description, message field 1224 may include other information, such as instructions about how to complete a particular disclosure form, and the purposes for which it is used, for example. The information displayed in message field 1224 may be linked to a particular disclosure form listed in disclosure field 1204. For example, in FIG. 12, message field 1224 displays information under the heading 1226 “Transfer Disclosure Statement Introduction.” Heading 1226 and other explanatory information displayed in message field 1224 may correspond to the disclosure document associated with tab 1228, labeled “TDS.” In an embodiment, to signal a user that the correspondence between the message in message field 1224 and the disclosure associated with a particular tab in disclosure field 1204, the respective disclosure tab may be highlighted, shaded, or provide some other readily-discernible indication that the window or web page associated with the respective tab is active, as described in connection with other features and functionality described herein. For example, in FIG. 12, tab 1228 is highlighted to signal to a viewer that the information in message window 1224 relates to the document associated with tab 1228 (i.e., “TDS”). In embodiments the message associated with a particular tab in disclosure field 1204 may be launched or accessed by some user activated method such as a “right-click,” or hovering a cursor over the relevant tab, or any other method used to launch or trigger the appearance of such information on a user interface or web page.

Embodiments may also include accessible help at various points of the transaction process, which may explain or provide tips on completing a particular step or process of the purchase transaction sequence. For example, help instructions 1230 on web page 1200 depicted in FIG. 12 may provide a description or instructions of how to access help. For example, help instructions may provide information about using icons such as help icon 829, illustrated in FIG. 8A. Referring again to FIG. 8A, help icon 829 may provide a link to help instructions or a description regarding offer status indicator 806. Information linked to help icon 829 may be accessed in various ways. For instance, clicking or hovering a cursor over help icon 829 may cause a new window or pop-up “bubble” to appear with the relevant explanation or instructions.

In an embodiment, as discussed above, tab 1228 may be associated with the “TDS” or “Transfer Disclosure Statement.” Indicator window 1218 thus reflects the completion status of steps or tasks related to the “TDS.” In FIG. 12, each of the indicators 1222 may be colored red (color not shown), indicating that none of the steps associated with the “TDS” has been completed by the originating party. When an originating party (seller, in this case), is prepared to work on the “TDS,” he or she may click button 1232, which may access or launch a web page or other deeper functionality configured to allow him or her to work on and complete step 1. For example, clicking button 1232 may launch or access functionality for reviewing or selecting forms, populating them with data, storing data and information in a database, and other functions helpful in finalizing and transmitting a disclosure document to another party to the transaction. When step 1 is completed, indicator 1222 associated with task 1220 corresponding to “Step 1,” may change to green, or some other visible indicia indicating that “Step 1” has been completed. The originating party can thus progress through the various steps associated with the “TDS” until all steps are complete, at which point the respective disclosure is sent to the receiving party for review and signature, as described above.

Returning again to FIG. 1A, the completion of escrow, disclosure, and other required tasks identified at box 26 may be checked at decision diamond 40. If all tasks are not completed, the status of each task is updated as seen at box 38, and the parties may continue acting to complete the tasks and progress toward completion may be tracked, as seen at box 36. The loop of acting to complete tasks, checking whether all tasks are completed, and updating tasks may continue iteratively until all tasks are completed. Once all tasks are completed, process 10 ends, as seen at button 42. Of course, at each stage of process 10 and sub-processes 100, 130 and 150, and at any point of any embodiment, data and communication between buyer, seller and any third parties involved may be stored in a database. Moreover, each party that enters data may grant broad or restricted access to other parties involved in the transaction, and to other third parties, as may be necessary or helpful to the transaction.

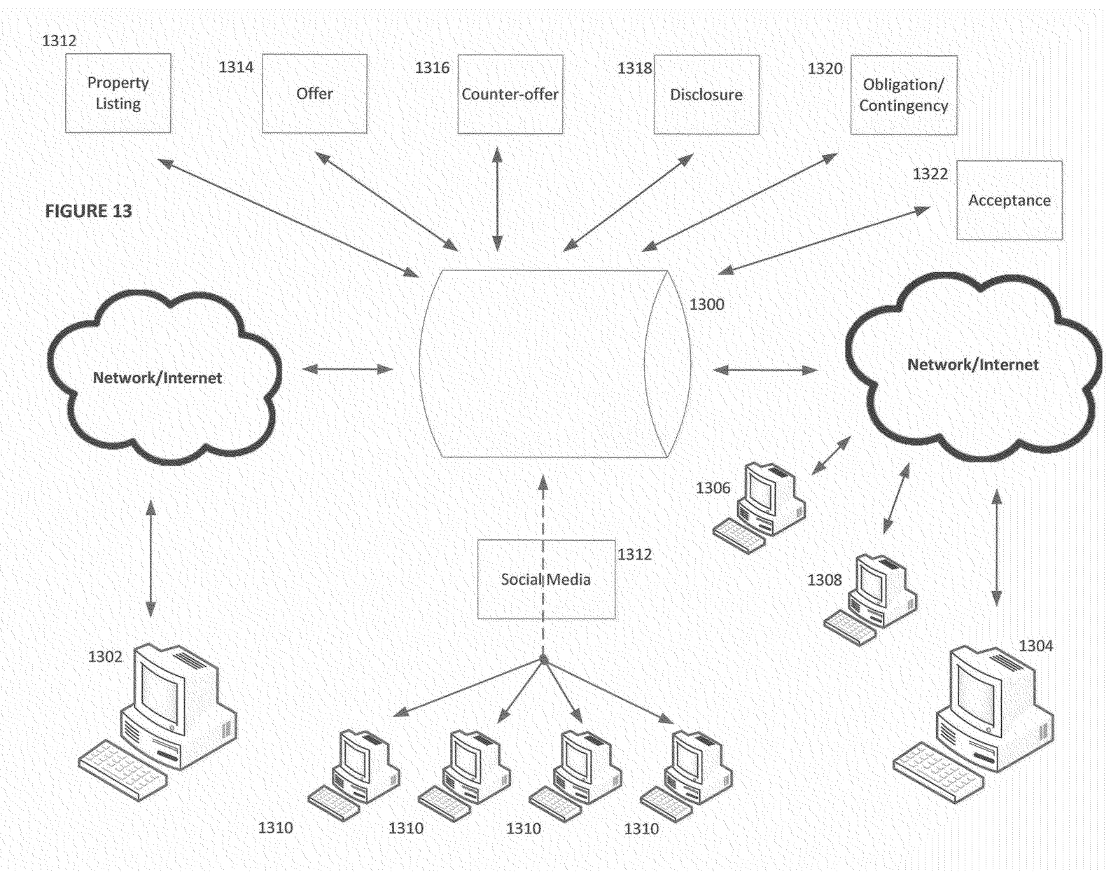

Referring now to FIG. 13, there is illustrated a block diagram illustrating data flows and interaction of various parties in an example embodiment. Database 1300 may provide for centralized storage and accessibility of all information generated by or gathered from a seller 1302, buyer 1304, or third-party information from other participants in a property transaction process or sequence, such as a third-party vendor 1306 or broker/agent 1308, as well as information regarding and gathered from shoppers 1310, who may not formally engage in an offer-transmitting process, such as contact information for instance. For example, when a seller 1302, buyer 1304, or shopper 1310 enters identifying information, property data or comps, or other information relevant to creating an account, making an offer, making a counter-offer, accepting an offer, generating obligations or disclosure documents, responding to any such items, or making any other transaction-related communication, the information may be stored in database 1300. Moreover, any information generated during the transaction process or purchase transaction sequence, or through interaction with a third-party vendor 1306 or an agent/broker 1308, for the provision of ancillary or “a la carte” services, such as obtaining MLS and non-MLS listings or the generation of “for sale” signs, for example, may also be stored in database 1300. Information stored in database 1300 may be used to generate or populate property listings 1312, as well as form documents and templates for offers 1314, counter-offers 1316, disclosures 1318, obligations/contingencies 1320, acceptances 1322, or any other forms, templates or other transmittals or communications used or made throughout the process. As discussed above, form documents and templates may exist in database 1300, readily accessible for use by the seller 1302, buyer 1304, vendor 1306, broker/agent 1308, and other parties participating in a transaction process or purchase transaction sequence. Information may thus flow between database 1300 and any of these sources of transmitting or communicating information between parties. As discussed herein, such communications may be made through various methods and means, including their transmission over networks such as the Internet.

Furthermore, a seller may elect to utilize social media or other means of showing or displaying property listings to shoppers and potential buyers. For example, a seller may authorize a connection between database 1300 and a social media network 1312, such as Facebook®, Twitter®, or LinkedIn°, for example, so that the property listing may be distributed by one or more social networks to many more shoppers 1310. Such networks may exist on or be facilitated through various methods and means such as networks, including the Internet, for example. Of course, shoppers 1310 may also establish direct connections to the database in accordance with embodiments (not shown). In addition, distribution and data sharing may be controlled or limited to those with particular needs or authorization to view or receive certain data. For example, a third-party vendor may not need to see a buyer's mortgage approval status, and embodiments may provide for keeping certain information from disclosure to certain other participants.

### Buyer-Initiated Target Research and Offers

As discussed above, prospective buyers may discover properties that are on sale through various publication and other methods. As also discussed above, buyers identifying a property designated “for sale” may directly engage a potential or prospective seller to move forward with a sale-purchase transaction. In an embodiment, a buyer may assemble an offer on any property, regardless of whether or not it is designated or listed as “for sale” at the time of the buyer's interest. As will be discussed in greater detail, below, the mode of a property sale transaction process or purchase transaction sequence may thus shift from initiation by a seller or a seller's agent (by placing the home for sale), to initiation by a buyer or buyer's agent (by submitting an offer). Buyers or their agents (if applicable, but not required) may thus submit offers relating to any property, whether it is being listed or offered for sale or not; and, if listed for sale, regardless of the mode or channel on which a property may be listed or offered for sale (e.g., FSBO, MLS, social media, Internet syndication). As a result, buyers may be empowered to initiate and conduct transactions on their own, which allows them to: i) capture cost savings that result from not engaging an agent; and ii) drive transactions more quickly regarding desired properties. The ability to compile relevant information, generate offers and related documentation, and submit offers and documentation directly to sellers allows buyers to bypass time-consuming steps of scheduling property viewings or tours with the property owner, as well as the buyer's agent and seller's agent. Moreover, a buyer is thus empowered to immediately submit an offer on a property of interest, rather than enduring a cycle that may include waiting for buyer's agent to compile and draft offer paperwork and ask further questions or seek further clarification, before sending a finalized offer package to the buyer for review and signature, and finally sending the offer package to the property owner.

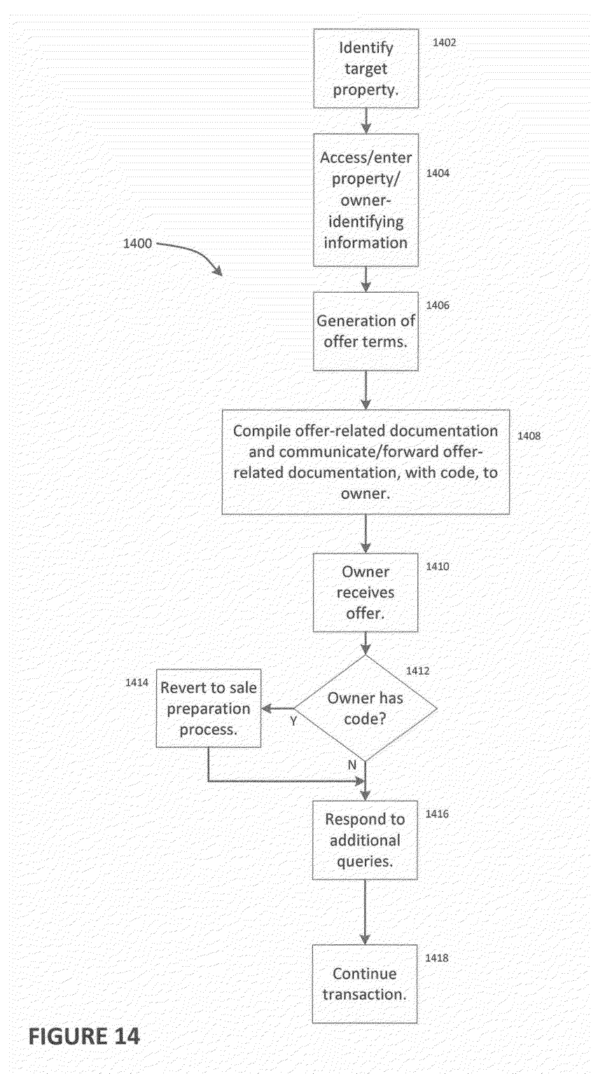

Referring now to FIG. 14, there is illustrated a process 1400 in accordance with an embodiment, whereby data and information may be gathered, compiled and stored, such as in a collection (e.g., database, as described above), so that a buyer may submit an offer to a property owner. As discussed above, a property of interest to the buyer may be listed or offered for sale in any manner or on any channel (including, without limitation, any listing or channel in accordance with embodiments described herein), or may not be listed or offered for sale at all. At box 1402, a buyer may thus search and identify a target property, or property of interest.

At box 1404, the buyer may access or enter data related to a target property for which the buyer desires to make an offer. Certain information that is necessary or useful to make an offer may include the property address, parcel number, and current owners' names. Such information may be generally obtainable through publicly-accessible sources such as an assessor's office, other government office, or other resources. Such information may also be available through other channels or sources, including without limitation, those described in connection with other embodiments and examples set forth herein. In embodiments, functionality may be provided for the automated searching of data corresponding to properties, in a buyer-defined area. This may allow a buyer to specify a particular geographic area, and search properties to obtain information such as, for example, property address and parcel number. Similar functionality may be provided for searching the names/identities of the respective property owners. Such automated search functionality may query and retrieve relevant data from publicly-available sources such as assessors, proprietary third-party sources, or from databases compiled and populated through embodiments described herein.

To compile and store information relevant to making an offer on a target property or property of interest, a buyer may access a property listing and transaction platform in accordance with embodiments discussed above. Buyers may be individuals, or groups of buyers, such as syndicates, trusts, or corporations, for example. In embodiments, a buyer or group of buyers may be required to establish one or more accounts to access a property listing and transaction platform, and account security measures and procedures may be implemented, as discussed above. Such procedures may require, for example, a buyer to login before accessing certain functionality for generating and submitting an offer.

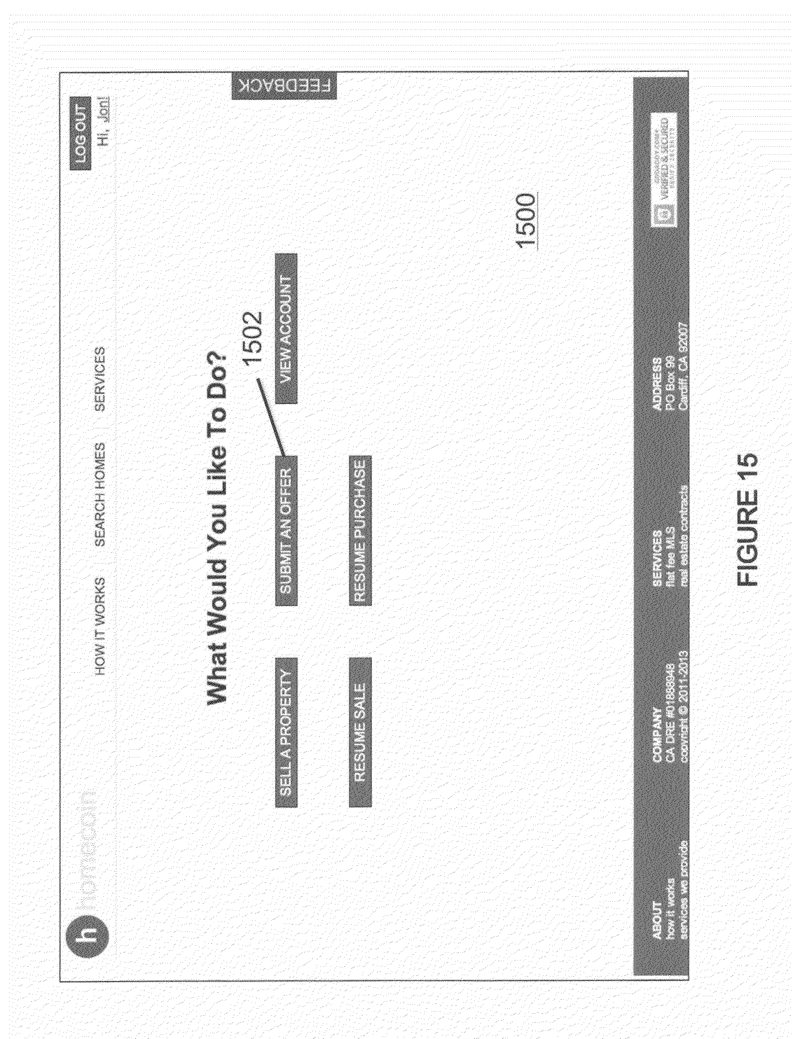

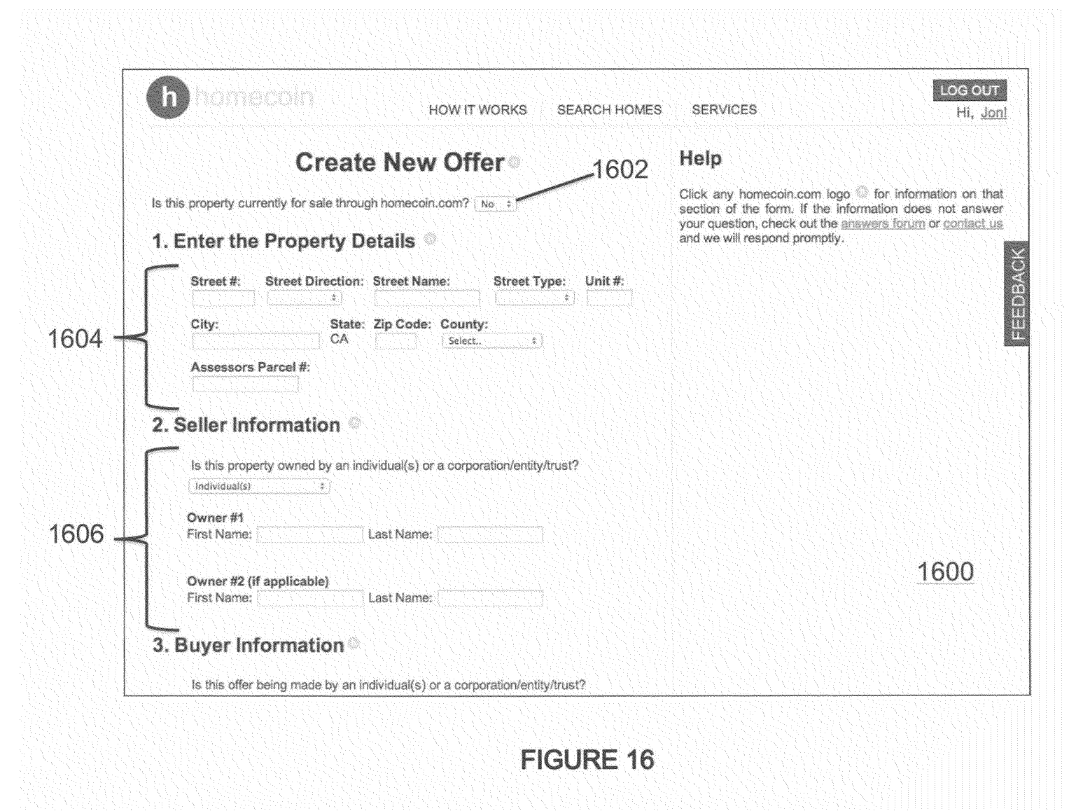

In an embodiment, as illustrated in FIG. 15, a buyer may initiate the process of entering data for compilation of an offer by visiting web page 1500, and clicking button 1502 “SUBMIT AN OFFER.” A buyer may then be presented with a web page 1600, as seen in FIG. 16, for the entry of certain data necessary or useful to generate and transmit an offer to a property owner. Pull-down menu 1602, may be provided for responding to an inquiry as to whether the property of interest is already listed on a respective listing or offer service, such as those described in connection with embodiments herein. In the event that a property is so listed, responding “yes” may trigger the automatic population of other fields on page 1600 with the relevant information from a respective database or other data storage. Otherwise, if data regarding a respective target property is not included or accessible, a buyer may enter data such as the property address in “Property Details” fields 1604. Identification information regarding the owner or seller of the target property may similarly be entered in “Seller Information” fields 1606. Web page 1600 may include various other inquiries, directions, pull-down menus, and other modes of requesting and capture of relevant and helpful data.

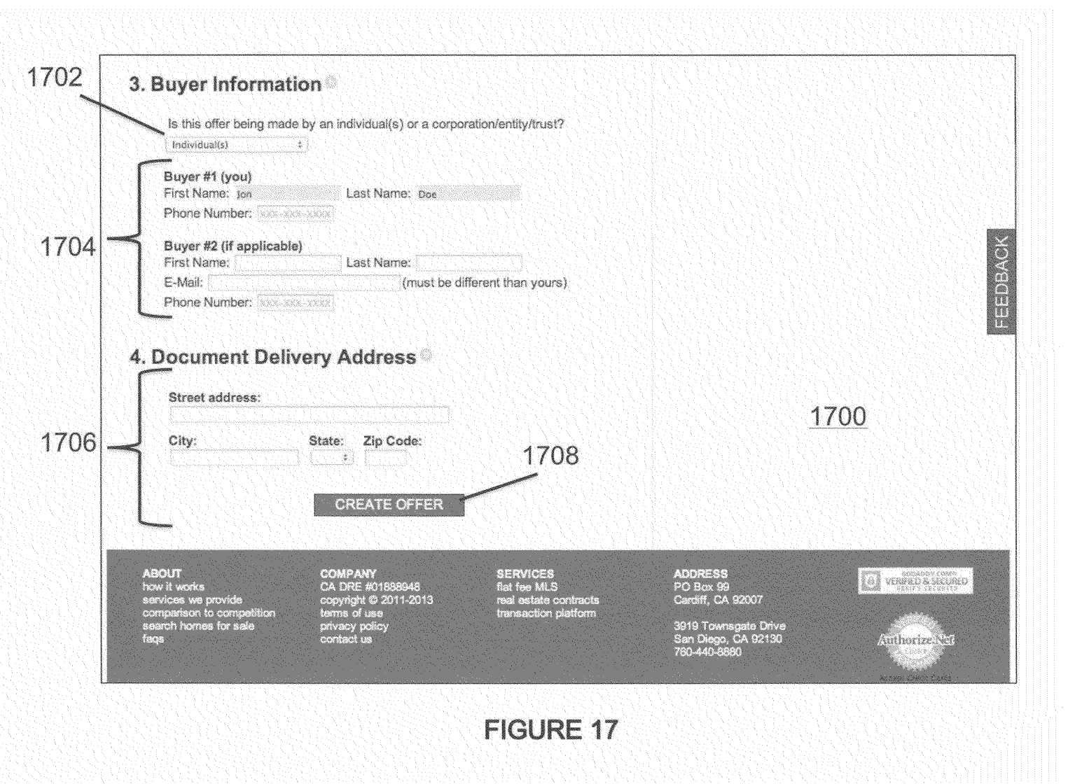

Also, data capture relevant to the offer may be continued on another page, such as web page 1700, illustrated in FIG. 17. For example, a buyer may respond to an inquiry regarding whether the buyer is an individual or corporation/entity/trust, by using pull-down menu 1702. Relevant data identifying or more buyers (persons or entities), and other relevant information such as contact information, authorized representative or agent, and a document delivery address may be requested and input in fields 1704, 1706. This and other information may be recorded and stored for future use, such as in connection with authorizing and accepting various aspects of an offer and purchase transaction, as will be discussed in greater detail, below. Functionality may be provided to automatically contact identified persons such as other involved buyers, representatives and agents, for example, when an offer is submitted. Such notification or contact may be facilitated through email, text message, for example. Of course, if an agent, buyer or other user has previously entered identifying information (discussed above, in connection with certain embodiments), the information may be automatically populated in appropriate locations, so it does not have to be repeatedly entered. The agent, buyer or other person may be identified at initial login for such purposes. Upon providing the requested information, a buyer may click button 1708, “CREATE OFFER,” to continue with the process.

It is to be appreciated that help functionality may be incorporated into embodiments, as discussed above, where a user (buyer, seller, or other) may obtain further guidance and information about the process of buyer preparing and making an offer and concluding a transaction with a seller. In addition, as discussed above, data entered throughout the offer and purchase negotiation process may be captured and stored for future use, including population of related transaction forms and other purposes.

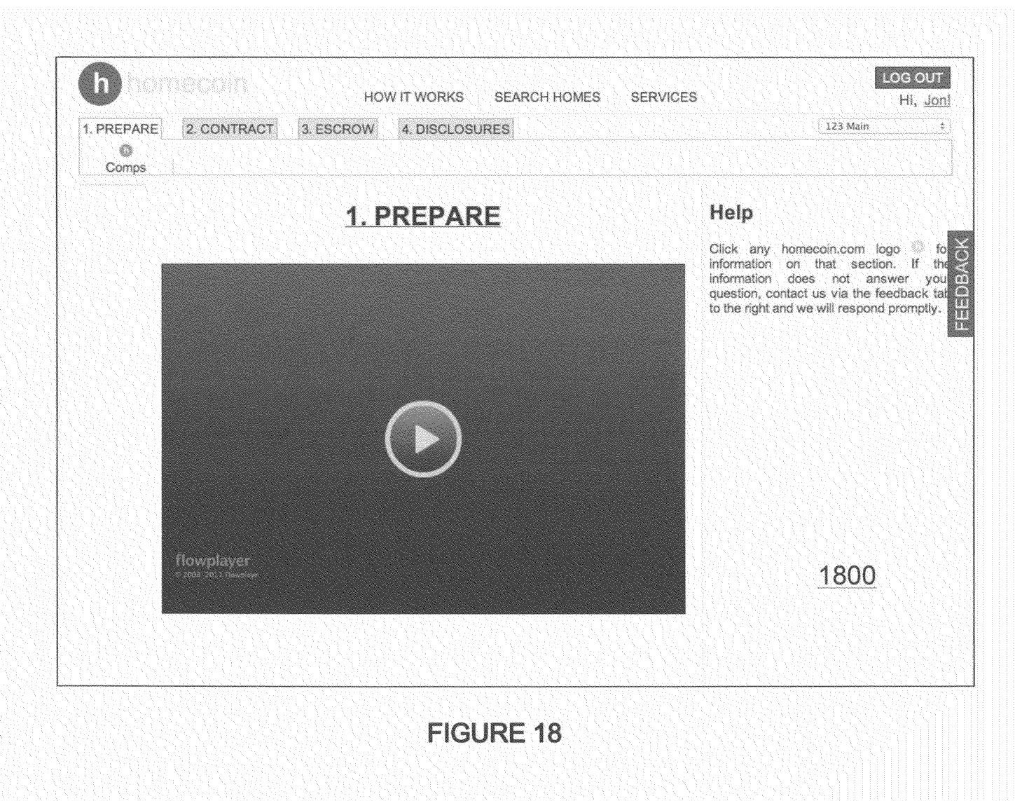

Returning now to FIG. 14, box 1406 illustrates the generation of offer terms. After clicking button 1708 (FIG. 17), a code may be generated that is unique to the target property. The unique code may be stored, such as in a database discussed above in connection with embodiments, for example. Other information regarding the offer for this respective property may be stored together, or in a manner that provides for easy reference and cross-reference. At this point, a web page 1800, as illustrated in FIG. 18 may be displayed to a buyer, and directions or links may be provided for a buyer to access functionality such as that described above and as seen initiating at box 20 of FIG. 1 and in FIGS. 5 through 7. A buyer thus completes and inputs the other relevant information needed for the offer and generation of respective documentation, as illustrated at box 1508 of FIG. 15. Functionality may be provided for the buyer to generate a printout or other display of the offer at any stage of the process. Also, the offer may include instructions for the target property owner, or the owner's agent, to respond or take action on the offer. These instructions may include the unique code, and directions to login or establish an account to view and respond to the offer in accordance with embodiments.

It is to be appreciated that functionality, as discussed above, for indicating completion status regarding particular process steps and tasks of each party, as well as the entry of certain data items, may be implemented in connection with embodiments. For example, color-based indicia or other indicators as discussed above, may be utilized to indicate which steps a buyer or seller may have completed, or which steps remain outstanding. As another example, indicators and alerts may be implemented in connection with any steps of processes in accordance with embodiments herein, to show that certain items or documents must be submitted, or that they may require signature.

As illustrated at box 1410 of FIG. 14, after the offer is completed and signed by the buyer(s), it may be delivered to the property owner at a known address of the property owner or the owner's agent. In embodiments, functionality may be provided for a buyer to search and identify the tax address where tax bills are sent to the property owner.

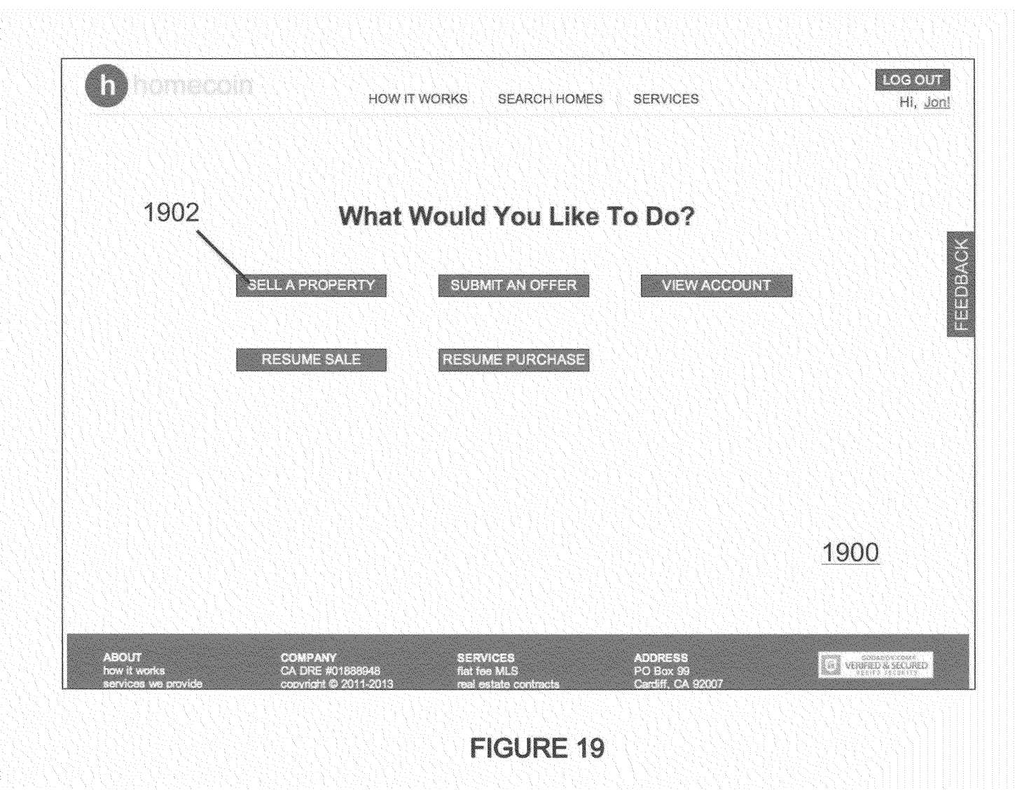

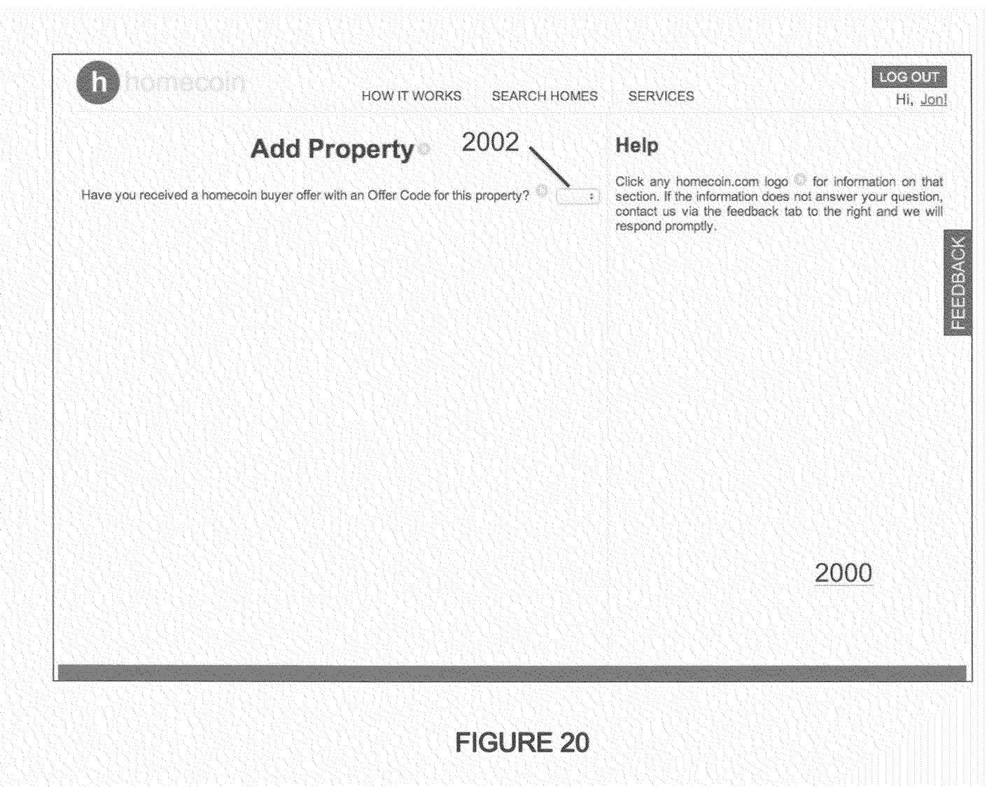

If the property owner decides to take action on the offer, the owner or respective agent may login to respond or engage the buyer utilizing embodiments described herein. As discussed above, the property owner may have established an account and or posted a property for sale previously. If the owner does not have an account, he or she may be required to create one, as also discussed above. Upon login or creation of an account, the property owner may be directed to a web page 1900, as illustrated in FIG. 19. The owner or agent may click button 1902, “SELL A PROPERTY,” to continue. As illustrated in FIG. 20, the owner or agent may then be asked via web page 2000 whether he or she has received a code provided by a buyer making an offer as discussed above. The owner or agent may respond by utilizing pull-down menu 2002. This is also illustrated at decision diamond 1412, of FIG. 14.

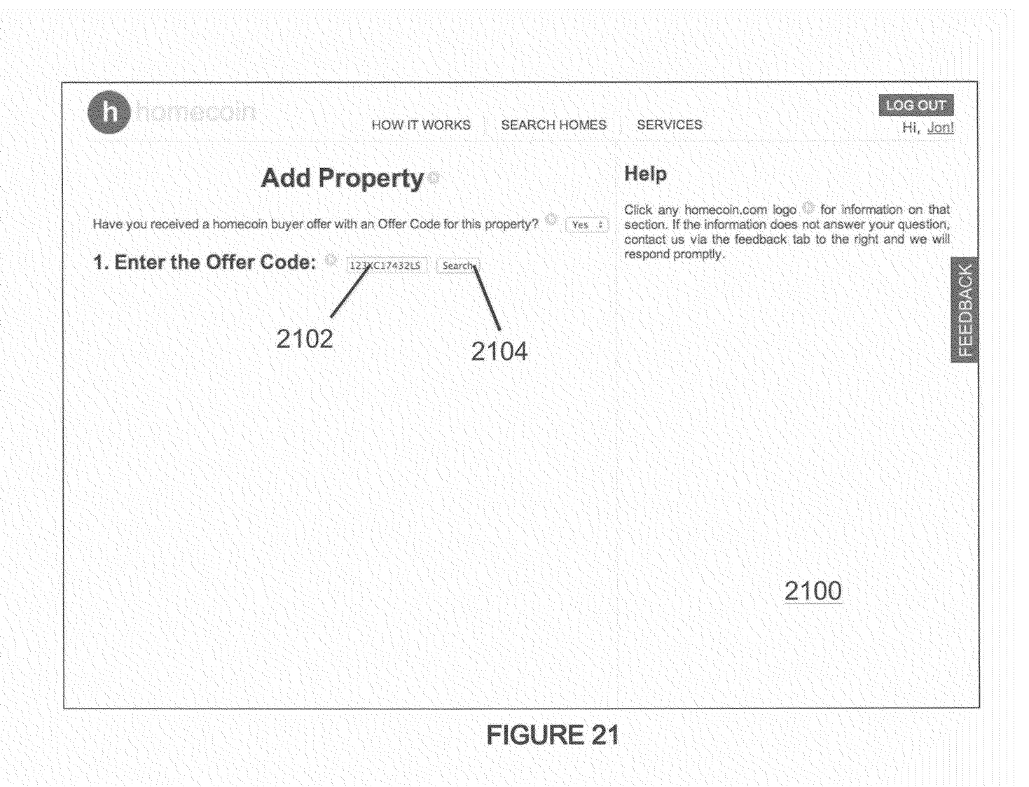

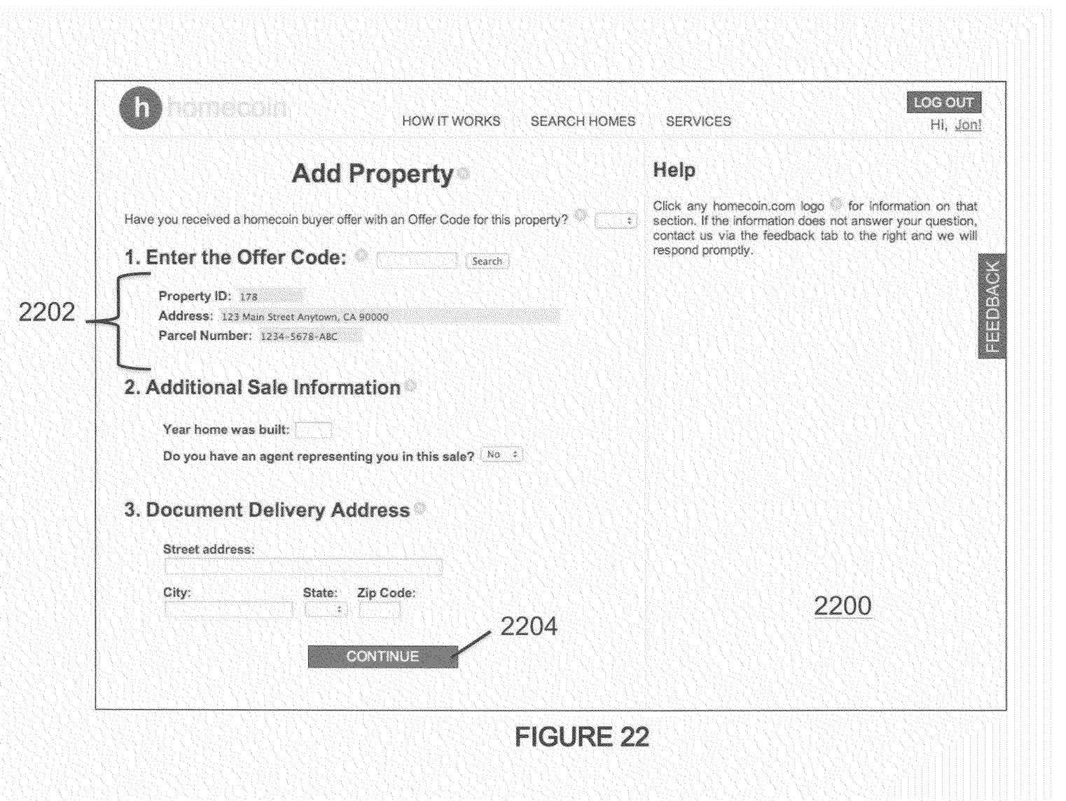

At this point, if the owner or agent does not have a code from a buyer, the owner or agent may be directed to proceed with a process such as described above in connection with FIGS. 1A-D and FIGS. 2-4, regarding a seller's preparation of a listing for sale. This is also illustrated at box 1414 of FIG. 14. If, on the other hand, the owner or agent does have a code, the owner or agent may be prompted via web page 2100 to enter the respective code in box 2102 and click the “SEARCH” button 2104, as illustrated in FIG. 21. Upon entry of the code, the database or other offer storage utility may be searched for the corresponding offer, and the address of the target property is displayed to the seller on web page 2200, in fields 2202, as illustrated in FIG. 22. As illustrated at box 1416 of FIG. 14, the property owner or agent may be queried other information such as the year the home was built, or to confirm whether the seller is, in fact, represented by an agent in connection with the transaction, along with a request for the agent's license and contact information, firm name, etc. Other queries may include, for example, whether other owners are involved, requests for the other owners' contact information and for them to create accounts in accordance with embodiments, and a document delivery address for the owner or agent. Parties such as other owners and agents may be automatically contacted via email, text, or other appropriate methods, in accordance with the respective contact information that is provided, to notify them that they have been added to the offer. Of course, if the owner or agent responding to the offer has an account in accordance with embodiments, such information may have been stored and may be automatically entered in respective fields in response to the queries. If not, other owners or agents may be asked to establish an account before participating in the transaction in accordance with embodiments.

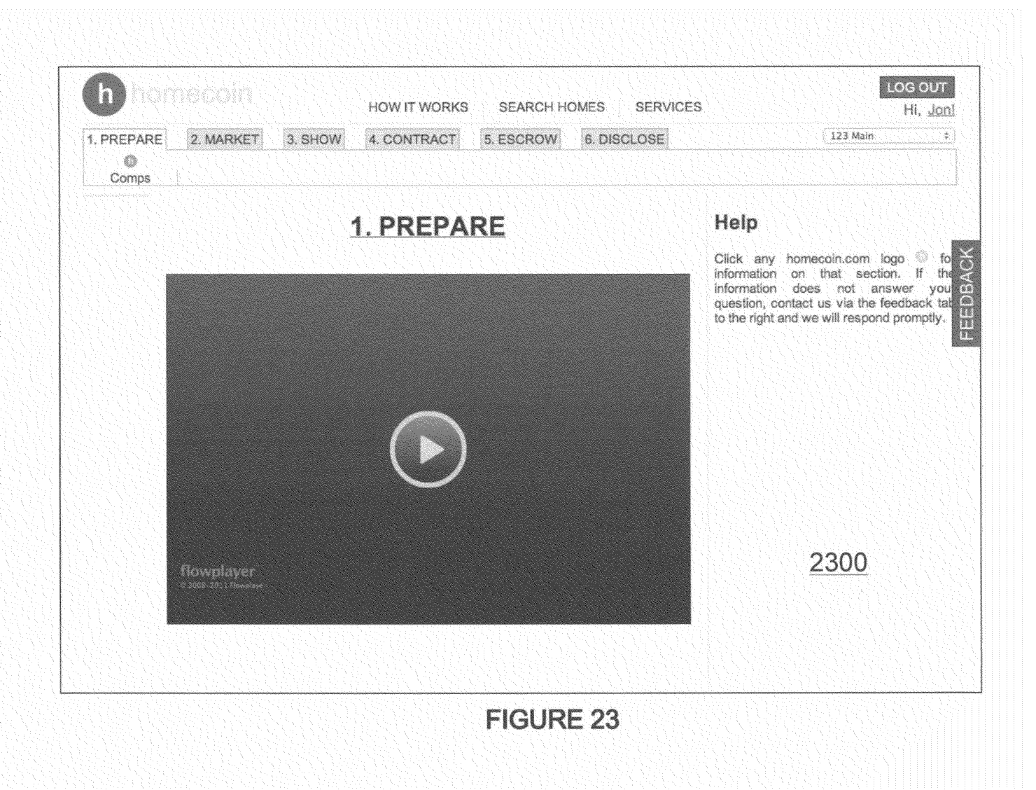

Once the owner has provided all the requested information, he or she may click button 2204 “CONTINUE” of FIG. 22, and a web page 2300, as illustrated in FIG. 23 may appear to the owner. Clicking button 2204 will also trigger the launch of the sale functionality described above for continuing a sale transaction after an offer has been made, as depicted in FIGS. 8-13 and explained in the related description, above.

### Service Provider Profiles and Integration

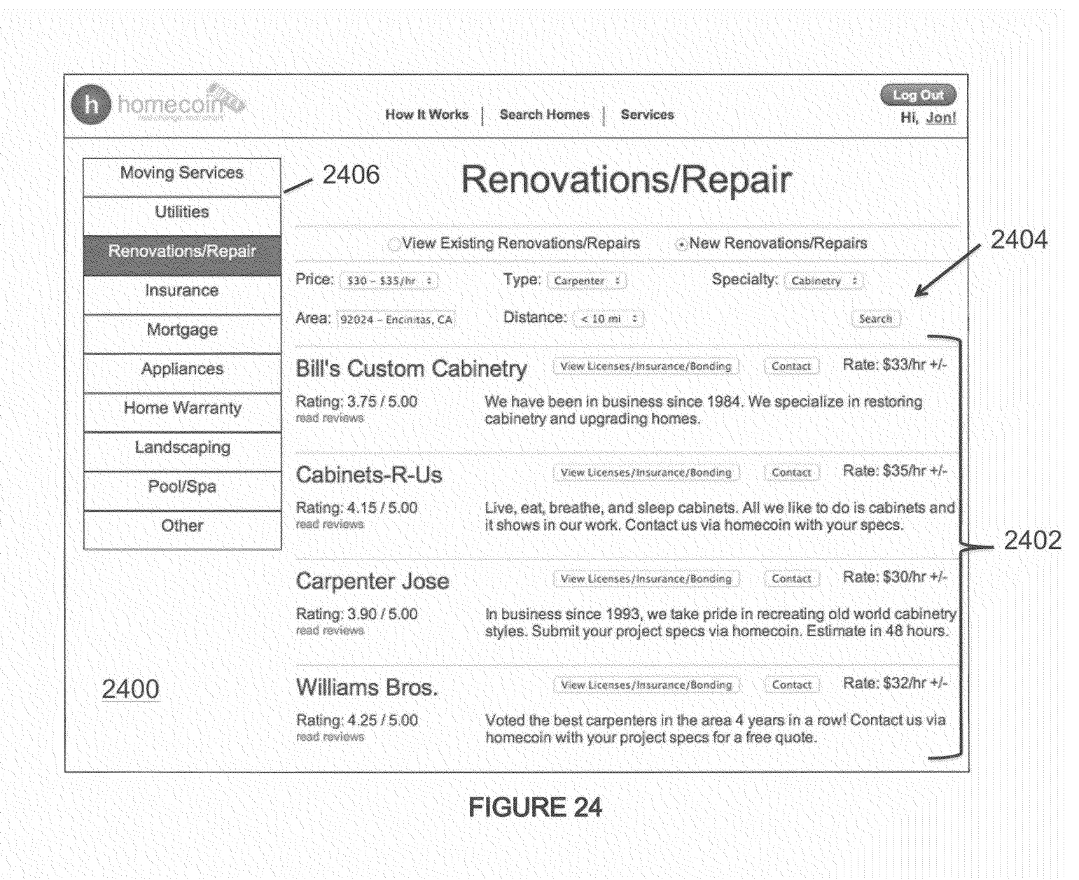

As discussed above, various third-parties such as real-estate brokers, agents and other service providers may be contacted through functionality included in embodiments. Services may include the provision of real-estate sale signage, mortgage-related services, title services, landscaping, and various other services related to real estate transactions and home ownership. In fact, there is no limit as to the type of services that may be made available to buyers, sellers, and other users of embodiments described herein, whether or not they are account holders. Indeed, embodiments may include a marketplace where those in need of services may search and find service providers. For example, third-party service providers may create accounts including third-party information regarding their offerings, and other information about themselves, such as, without limitation, licenses held, other accreditations, costs and fees for services, previous experience (including work in connection with other transactions facilitated through embodiments), geographical areas served, and other information. This provision and availability of such third-party information is advantageous to prospective clients, as they are empowered to evaluate and compare offerings between service providers. As an example, FIG. 24 illustrates a webpage 2400 showing a comparison list 2402 of renovation and repair service contractors, with descriptions, contact information and reviews for each. Such a list 2402 may be compiled when a user (e.g., a buyer or a seller) specifies particular parameters such as a range of hourly rates desired, type of repair needed, contractor specialty, geographic area, and distance, as illustrated by the pull-down menus in field 2404. Menu 2406 allows a user (e.g., a buyer, seller, shopper, or other user) to find and compare providers for various goods and services.

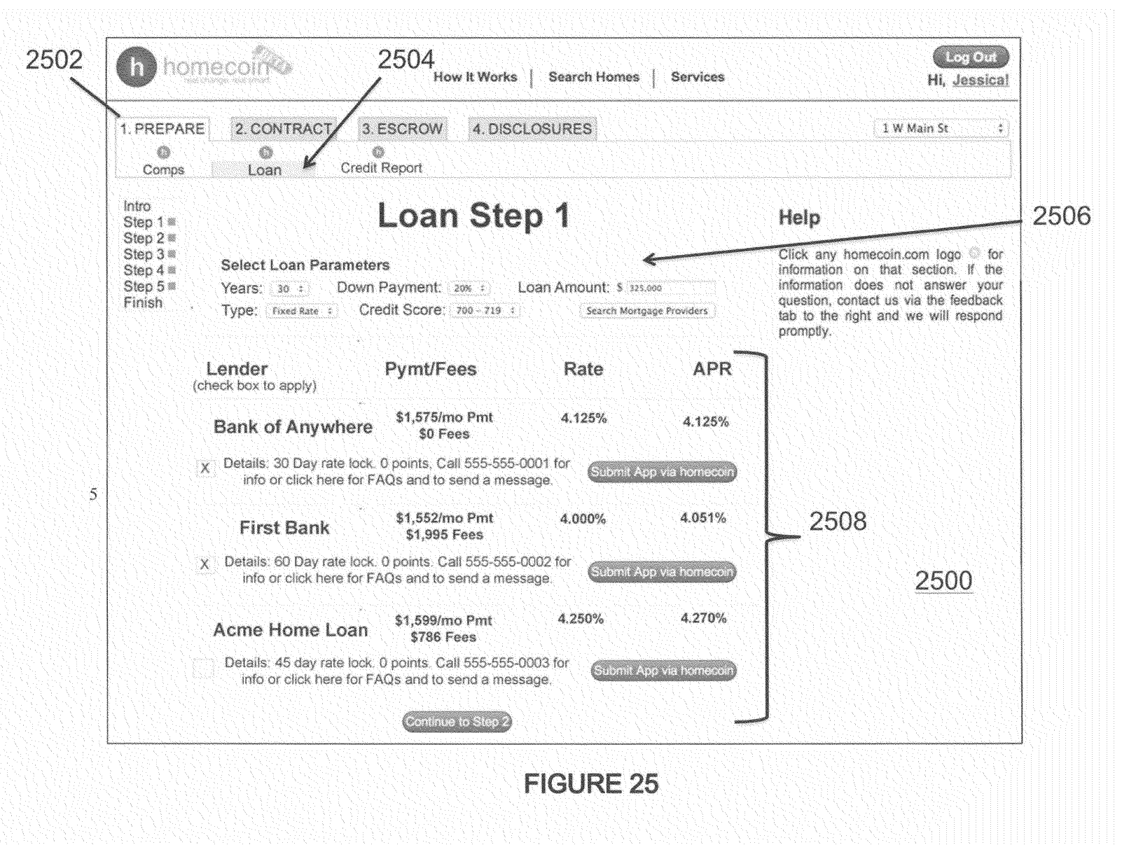

As another example, FIG. 25 illustrates a web page 2500 showing a comparison of third-party information, e.g., mortgage loan rates, as an integrated or additional step of a broader purchase transaction sequence, such as described in connection with other embodiments. When progressing through the “Prepare” stage, accessed through tab 2502, a user (buyer, for example), may click the “Loan” link 2504, as described in connection with other embodiments and features herein. To illustrate that “Loan” link 2504 is active, it may be shaded, or employ other visual or non-visual indicia, as also described herein. Upon the setting of parameters in field 2506 by a user, list 2508 may be returned, enumerating several loan options, as well as the name of the bank offering the loan, and additional terms such as projected payment, fees and interest rates, for example.

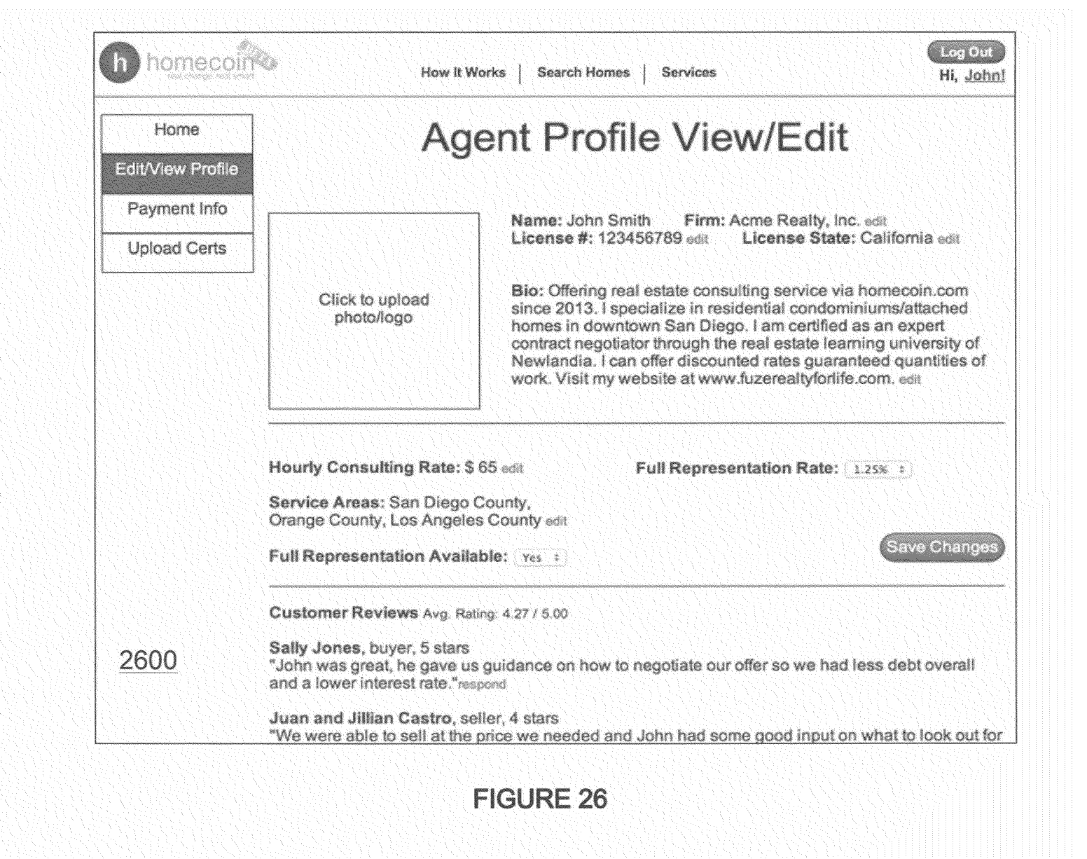

In another embodiment, real estate agents may be able to post, list, or otherwise make available other third-party information such as their hourly costs for services to buyers, sellers and other users, whether for an entire transaction, or for consultation as to particular aspects of a transaction. For example, FIG. 26 illustrates a web page 2600, showing a profile of a real-estate agent, and indicating relevant third-party information such as the agent's hourly rate, license number, firm name, service areas, customer reviews, etc. Web page 2600 may incorporate various features of functionality described in connection with other embodiments. Such third-party information may be input, gathered, aggregated, and stored in a collection, which may comprise a database, as described in connection with other embodiments. Introductions to, and vetting of, service providers, contracting for services, and payment arrangements and payments themselves may be facilitated through embodiments at any time during the course of a transaction, or even outside the transaction process or purchase transaction sequence. For example, embodiments may include credit card acceptance functionality, third-party payment processing, and other appropriate payment systems applicable to these types of transactions. In addition, functionality may be available for customers and clients of service providers to submit feedback, respond to surveys, and provide reviews regarding the services. Such information may be made available to others who are considering engaging the service providers. The service provider functionality and integration may be provided or combined with other embodiments described herein. Any or all of the third-party data and information regarding service providers, as well as related communications and input from buyers and sellers may be stored and aggregated in a collection (e.g., database) for easy retrieval, parsing, and populating transaction documents, as described in connection with other embodiments. In addition, and functionality may be provided to allow the automatic or manual generation of documents and contracts by which a user may engage a service provider, as discussed above.

Value this Offer Feature

In addition to other functionality described herein, embodiments may also include a feature allowing buyers to readily asses the total of additional costs that may be incurred in connection with a purchase transaction, beyond the actual offer amount. Such a feature provides important guidance and information to a buyer as to the total financial obligation that will be incurred with respect to a transaction, and thus review, evaluate and assess the total value of the offer and transaction.

In embodiments, such a “total cost” tool, or offer calculator, may extract or retrieve data from an offer form prepared by a buyer, such as the offer amount, additional services required or requested in connection with a transaction (e.g., escrow, title, etc.), and any additional offer terms. The “total cost” tool or offer calculator may assign estimated costs to each such item or service, as well as indicating which party will pay for the particular item or service (i.e., buyer, seller, agent, etc.), and provide an itemized list or simply a total cost amount. The costs of services may be exact or estimated. For example, where an item or service is provided by a service provider who has created an account or engaged in the “marketplace” functionality discussed above, exact costs information may be retrieved or accessed from the database or other repository of such stored information, and included in the “total cost” amount or itemization. Alternately, if a service provider's information is not available, the offer calculator may utilize figures based on historical transactions in a given geographical region, or such information may be input manually by a user or buyer.

Because embodiments may be database-driven, extensive data may be available for the offer calculator to tally, such as the specific services used in a particular contract (escrow, title, etc.), the cost of such services (from account holder and user profiles, historical transaction data, etc.), the party paying for those services (buyer, seller, etc.). This allows the cost calculator to arrive at the precise total value of an offer to a seller (and the total cost of the offer to the buyer). This may be advantageous to users buyers and sellers, because it increases the transparency of costs in real estate transactions and allows users, buyers and sellers to make more informed decisions in assembling and making offers, counteroffers, and ultimately deciding whether to accept a contract and complete a transaction regarding a property. In addition, offer calculator functionality may include the gathering, compilation and presentation to users, buyers, and sellers, of certain additional information and costs that are not easily quantifiable by a computer. For example and not for purposes of limitation, when a buyer/seller adds an additional term to the contract stipulating the exchange of personal property as part of the contract, relevant queries may be posed to the buyer, seller, and other involved parties; and information regarding this exchange may be added to the final cost tally or itemization presented by the offer calculator.

In embodiments, the offer calculator functionality may be activated by a buyer, seller, or both parties, to run in the background as it quantifies the debits/credits for each party for a given offer, while negotiations progress regarding a transaction, as discussed above in connection with various embodiments. The calculator may employ JavaScript® (a client-side web technology) to quickly calculate and update the value of an offer as the buyer or seller makes adjustments to the value of each debit/credit. The party entering the respective data may simply select or input whether an item is a debit/credit, the value/amount, and the percentage share that the party is accountable for and the offer calculator may generate or update the total value of an offer and/or the cost of an offer.

The offer calculator functionality may also allow parties to a transaction to make their own adjustments to the offer calculator for items that are difficult for a computer to quantify. Once debits/credits and other relevant information have been input into the offer calculator, the data can be saved to a database for later review and further adjustment, thus facilitating easy comparison to other offers (for sellers) or a better understanding of a total transaction cost (for buyers). The offer calculator tool may be particularly valuable for sellers and provide “at a glance” comparisons, in a multiple-offer environment where easily grasping and understanding the value of competing offers can be difficult and time consuming.

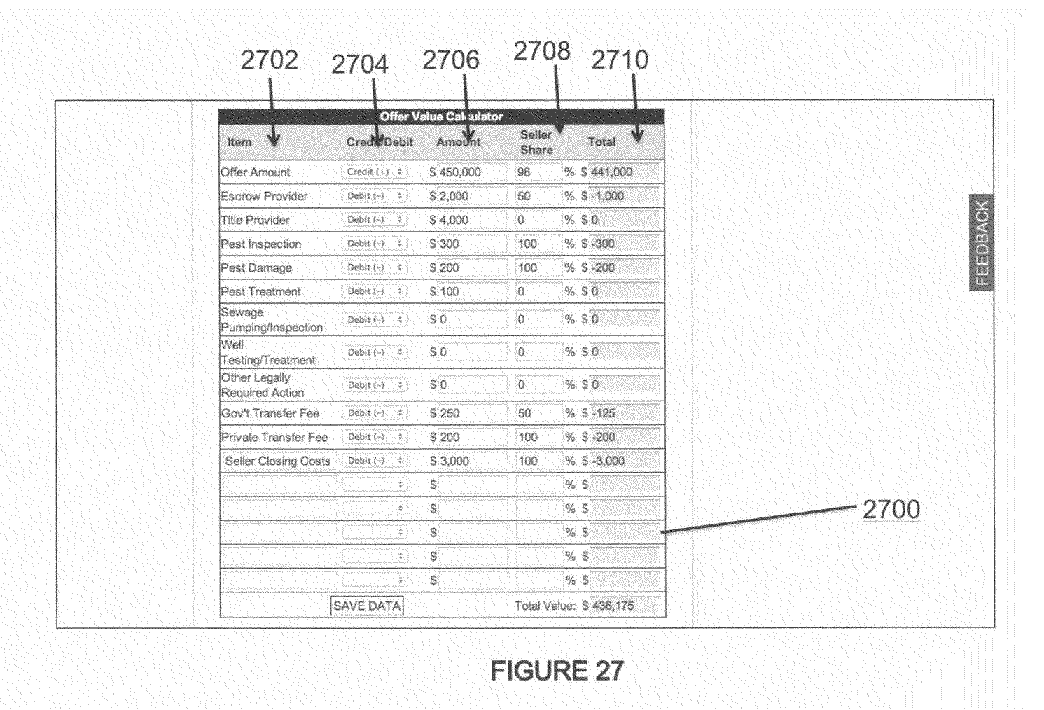

Embodiments employing a data-driven offer calculator as described may thus provide a key advantage over typical real estate transactions which are human-driven, and may not be conducive to quick and automated tracking of the total value of an offer. By leveraging the storehouse of data available regarding users, buyers, sellers, service providers, and historical transactions, embodiments may provide a rich, effective, and up-to-the minute snapshot of the value of an offer. For example, FIG. 27 illustrates an exemplary list 2700 that displays a number of items related to a contemplated transaction, with an associated monetary value. Such a listing may be incorporated or integrated with other features and functionality of embodiments described herein, such as on an additional web page relating to a particular transaction. The list may includes columns 2702, 2704, 2706, 2708, 2710, respectively corresponding to items such as: i) the particular item being valued (e.g., offer, closing costs, etc.); ii) whether the item and associated cost constitute a credit or debit; iii) the amount of the associated cost; iv) the seller's share (may also be designated as “buyer's share,” or any other appropriate designation); and v) indication of the impact of each itemized cost on the total cost/value of the offer. A “Total Value,” 2712, corresponding to a particular offer and illustrating the net impact of all the cost items may be output at the bottom of list 2400.

### Payment and Escrow Validation Functionality

For transaction-facilitation services provided in connection with embodiments, billing and payment functionality may be tied to the closing of a transaction, and the billed costs may be paid out of escrowed funds. Accordingly, embodiments may include functionality whereby a contract document may include instructions to an escrow holder that a specific payment amount for the transaction-facilitation services is to be paid upon the close of escrow. In keeping with the concepts described herein, information related to the escrowing of funds, i.e., specifics, in connection with a purchase transaction sequence may be gathered and stored in a collection (e.g., a database) with other information that is gathered and stored, so that the specifics are available for parsing and extraction for use in a property transaction sequence. The specifics may include, without limitation, items and information such as the amount/value of the escrow, escrow holder/bank identification and/or contact information, property-identifying information, amount of transaction fees, instructions, etc. A unique escrow validation code may also be provided to the escrow holder in connection with this functionality, when payment is to be made out of the escrow amount.

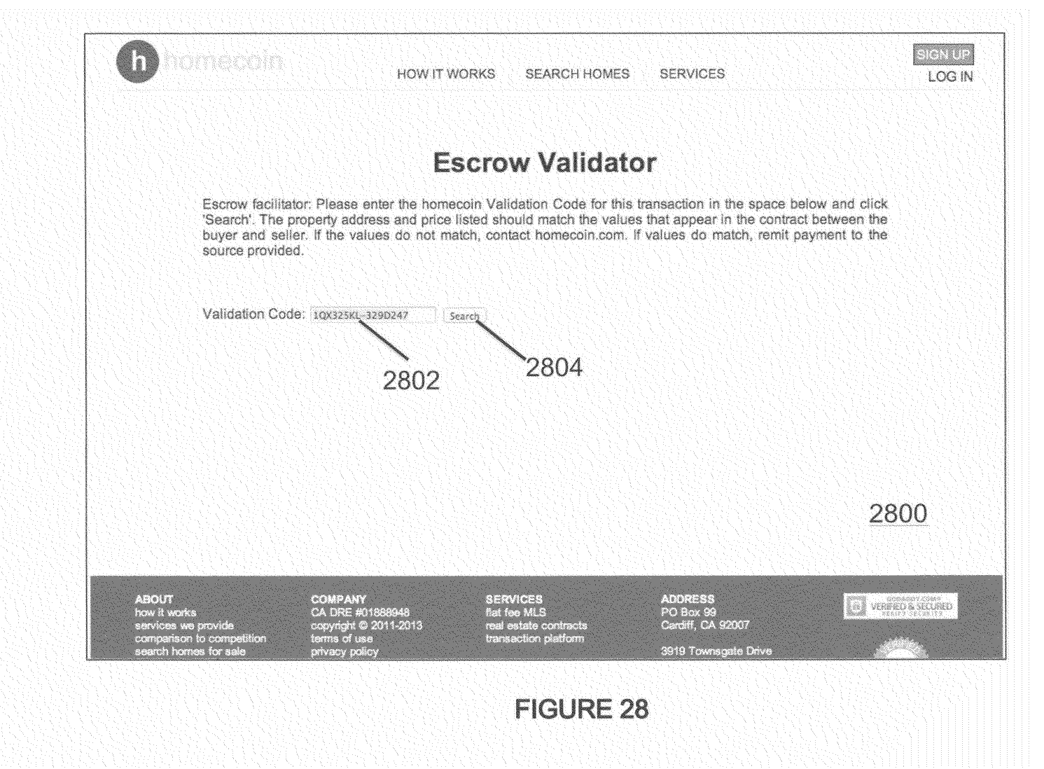

At the closing of escrow in connection with a transaction, the escrow holder may be provided with a particular website or URL to visit. Upon visiting the respective site, a webpage may be presented to the escrow holder, such as web page 2800, as illustrated in FIG. 28. Web page 2800 may include a field 2802, for entry of the escrow validation code. Upon entering the validation code, the escrow holder can submit it by clicking the “Search” button 2804.

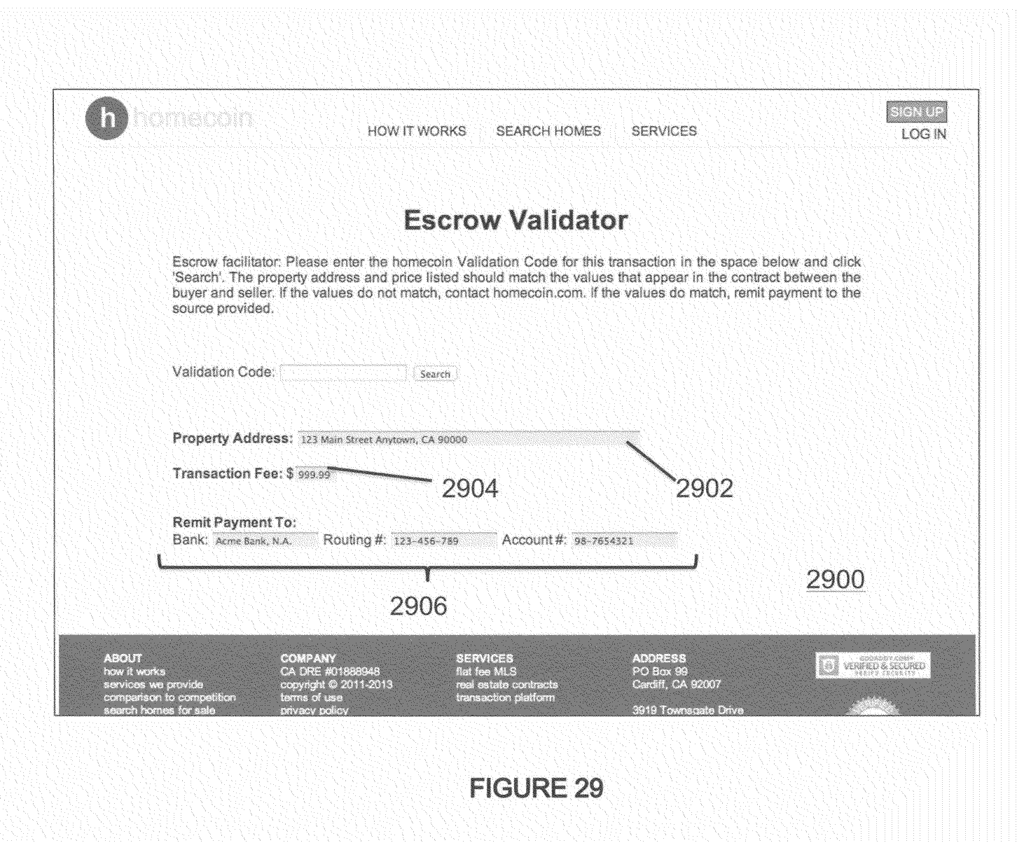

Clicking “Search” button 2804 may trigger the opening of another web page, or the display of property and transaction specific information. As illustrated in FIG. 29, for example, web page 2900 may display fields 2902, 2904, 2906, which include respective information such as the property address, transaction fee and payment remittance instructions. The escrow company would utilize this information to make payment for the transaction-facilitation services, out of the funds escrowed.

Such payment functionality may be advantageous for the transaction parties and provide an extra measure of comfort and trust in the management of the transaction. For example, once this payment procedure is established, the price listed in the contract will not be alterable by a user (i.e., once the escrow holder inputs the validation code, the contract price will be confirmed by the information in the escrow holder's possession). This provides an extra, final check of the data shared between the parties. In addition, users may be more favorably disposed to such a method of payment, as compared with payment of transaction-facilitation costs before a transaction closes.

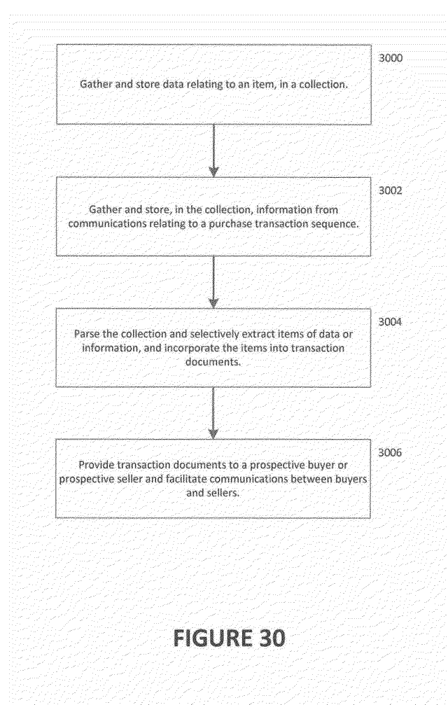

FIG. 30 is an exemplary flow chart of processes performed in accordance with various embodiments of a method, or systems and apparatuses for facilitating real estate transactions. At box 3000, data relating to an item for sale, or prospectively for sale (such as a piece of real property, for example), may be gathered and stored in a collection. At box 3002, information from communications relating to a purchase transaction sequence is also gathered and stored in the collection. As discussed above, this data and information may include, without limitation, home listings, buyer qualification data, comps, payment information, etc. At box 3004, the collection may be parsed such that items of the stored data and information may be selectively extracted and incorporated into transaction documents. As also discussed above, such documents may include, without limitation, offers, counter-offers, purchase and sale contracts, disclosure documents, contingency documents, acceptances, etc. In embodiments, such documents may comprise stored templates that may be populated with items of information or data, in the generation of appropriate documents for use between a prospective buyer and a prospective seller of a real property. At box 3006, transaction documents may be provided to buyers and/or sellers for use in documenting aspects of a purchase transaction and in closing the transaction.

### Computing Apparatus and Systems

It is understood that the various embodiments may be implemented individually, or collectively, in devices comprised of various hardware and/or software modules and components. Such a device, for example, may comprise a processor, a memory unit, and an interface that are communicatively connected to each other, and may range from desktop, server and/or laptop computers, to consumer electronic devices such as mobile devices and the like. Such devices may include input and peripheral devices, and other components that enable the device to read and receive data and instructions from various media, input devices, a network, or other inputting means in accordance with the various embodiments. It should be understood, however, that the scope is not intended to be limited to one particular type of device.

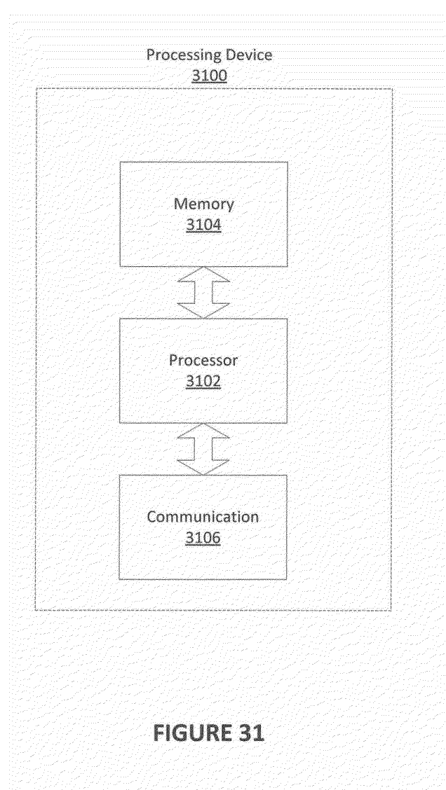

As an example, FIG. 31 illustrates a simplified block diagram of an exemplary device 3100 within which various embodiments may be implemented. The device 3100 comprises at least one processor 3102 and/or controller, at least one memory unit 3104 that is in communication with the processor 3102, and at least one communication unit 3106 that enables the exchange of data and information, directly or indirectly, with a communication medium, such as the Internet, or other networks, entities and devices. The processor 3104 can execute program code that is, for example, stored in the memory 3102. The communication unit 3106 may provide wired and/or wireless communication capabilities in accordance with one or more communication protocols and interfaces, and therefore it may comprise the proper transmitter/receiver antennas, circuitry and ports, as well as the encoding/decoding capabilities that may be necessary for proper transmission and/or reception of data and other information.

Similarly, the various components or sub-components within each module may be implemented in software, hardware, and/or firmware. The connectivity between the modules and/or components within the modules may be provided using any one of the connectivity methods and media that is known in the art, including, but not limited to, communications over the Internet, as well as wired, or wireless networks using the appropriate protocols.

Various embodiments described herein are described in the general context of method steps or processes, which may be implemented in one embodiment by a computer program product or module, embodied in a computer-readable memory, including computer-executable instructions, such as program code, and executed by apparatus such as computers or computing systems in networked environments. A computer-readable memory may include removable and non-removable storage devices including, but not limited to, Read Only Memory (ROM), Random Access Memory (RAM), compact discs (CDs), digital versatile discs (DVD), etc. As such, the various disclosed embodiments can be implemented by computer code embodied on non-transitory computer readable media. In other embodiments processes may be employed to perform operations on data, wherein the instructions for process operations and the data, or elements thereof, may reside on or be transferred through one or more computing devices or systems.

Generally, program products or modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. Various embodiments may comprise a computer-readable medium including computer executable instructions that, when executed by a processor, cause an apparatus to perform the methods and processes described herein. Apparatuses or systems utilized in connection with embodiments may be of a general-purpose character, or may be specially constructed, designed or programmed for the required purposes. In embodiments, such apparatuses and systems may be configured or activated by computer programs, instructions and/or data stored in or transferred into the apparatus or system.

Embodiments may be implemented in software, hardware, application logic or a combination of software, hardware and application logic. The software, application logic and/or hardware may reside on a client device, a server or a network component. If desired, part of the software, application logic and/or hardware may reside on a client device, part of the software, application logic and/or hardware may reside on a server, and part of the software, application logic and/or hardware may reside on a network component. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of such a device described and depicted in FIG. 31. A computer-readable medium may comprise a computer-readable storage medium that may be any media or means that can contain or store the instructions for use by or in connection with an instruction execution system, apparatus, or device, such as a computer. In one embodiment, the computer-readable storage medium is a non-transitory storage medium.

If desired, the different functions discussed herein may be performed in a different order and/or concurrently with each other. Furthermore, if desired, one or more of the above-described functions may be optional or may be combined.

Although various aspects are set out in the independent claims, other aspects comprise other combinations of features from the described embodiments and/or the dependent claims with the features of the independent claims, and not solely the combinations explicitly set out in the claims.

The foregoing description of embodiments has been presented for purposes of illustration and description. The foregoing description is not intended to be exhaustive or to limit embodiments to the precise form disclosed, and modifications and variations are possible in light of the above teachings or may be acquired from the practice of various embodiments. The embodiments discussed herein were chosen and described in order to explain the principles and the nature of various embodiments and practical application to enable one skilled in the art to utilize various embodiments, including various modifications as are suited to the particular use contemplated. The features of the embodiments described herein may be combined in all possible combinations of methods, apparatus, modules, systems, and computer program products.

What is claimed is:

1. A method, comprising:
gathering and storing, in a collection, data relating to an item;
gathering and storing, in the collection, information from communications, the communications relating to a purchase transaction sequence regarding the item;
parsing the collection to extract items of data or information and incorporating at least a portion of the extracted items into at least one transaction document relating to at least a portion of the purchase transaction sequence; and
providing at least one transaction document to at least one of one or more prospective buyers or one or more prospective sellers, through a platform adapted to facilitate communication between the one or more prospective buyers and the one or more prospective sellers.

2. The method of claim 1, wherein the item is a piece of real property.

3. The method of claim 1, wherein the collection comprises a database adapted to provide selective access to the data and information.

4. The method of claim 3, further comprising aggregating, in the database, third-party information relating to products and services from vendors; and
generating at least one comparison list based on and incorporating at least a portion of the stored third-party information.

5. The method of claim 4, further comprising providing for the escrow of funds relating to the purchase transaction sequence, wherein specifics relating to the escrow of funds are stored in the database.

6. The method of claim 1, wherein the purchase transaction sequence comprises a plurality of steps, the method further comprising tracking the progress of one or more of the plurality of steps.

7. The method of claim 6, wherein tracking the progress of one or more of the plurality of steps comprises communicating the status of the step to at least one of the one or more prospective buyers or one or more of the prospective sellers via status indicia.

8. The method of claim 7, wherein at least a portion of the status indicia are visual and color-based.

9. An apparatus, comprising:
a first module adapted to gather and store, in a collection, at least one of data relating to an item or information from communications, the communications relating to a purchase transaction sequence regarding the item;
a second module adapted to parse the collection to extract items of data or information and to generate at least one transaction document relating to at least a portion of the purchase transaction sequence, by incorporating at least a portion of the extracted items into the transaction document; and
a third module adapted to provide at least one transaction document to at least one of one or more prospective buyers or one or more prospective sellers, through a platform adapted to facilitate communication between the one or more prospective buyers and the one or more prospective sellers.

10. The apparatus of claim 9, wherein the item is a piece of real property.

11. The apparatus of claim 9, wherein the collection comprises a database adapted to provide selective access to the data and information.

12. The apparatus of claim 11, further comprising a fourth module adapted to aggregate, in the database, third-party information relating to products and services from vendors; and
generate at least one comparison list based on and incorporating at least a portion of the stored third-party information.

13. The apparatus of claim 12, further comprising a fifth module adapted to provide for the escrow of funds relating to the purchase transaction sequence, wherein specifics relating to the escrow of funds are stored in the database.

14. The apparatus of claim 9, wherein the purchase transaction sequence comprises a plurality of steps, the method further comprising means for tracking the progress of one or more of the plurality of steps.

15. The apparatus of claim 14, wherein tracking the progress of one or more steps comprises communicating the status of the step to at least one of the one or more of the prospective buyers or one or more of the prospective sellers via status indicia.

16. The method of claim 15, wherein at least a portion of the status indicia are visual and color-based.

17. A computer program product, embodied on a non-transitory computer-readable medium, comprising:
computer code for causing an apparatus to perform at least the following:
gathering and storing, in a collection, data relating to an item;
gathering and storing, in the collection, information from communications, the communications relating to a purchase transaction sequence regarding the item;
parsing the collection to extract items of data or information and incorporating at least a portion of the extracted items into at least one transaction document relating to at least a portion of the purchase transaction sequence; and
providing at least one transaction document to at least one of one or more prospective buyers or one or more prospective sellers, through a platform adapted to facilitate communication between the one or more prospective buyers and the one or more prospective sellers.

18. The computer program product of claim 17, wherein the item is a piece of real property.

19. The computer program product of claim 17, wherein the collection comprises a database adapted to provide selective access to the data and information.

20. The computer program product of claim 19, further comprising computer code for causing an apparatus to aggregate, in the database, third-party information relating to products and services from vendors; and
generating at least one comparison list based on and incorporating at least a portion of the stored third-party information.

21. The computer program product of claim 20, further comprising computer code for causing an apparatus to provide for the escrow of funds relating to the purchase transaction sequence, wherein specifics relating to the escrow of funds are stored in the database.

22. The computer program product of claim 17, wherein the purchase transaction sequence comprises a plurality of steps, the computer program product further comprising computer code for causing an apparatus to track the progress of one or more of the plurality of steps.

23. The computer program product of claim 22, wherein tracking the progress of one or more of the plurality of steps comprises communicating the status of the step to at least one of the one or more of the prospective buyers or one or more of the prospective sellers via status indicia.

24. The computer program product of claim 23, wherein at least a portion of the status indicia are visual and color-based.
